(19) United States
(12) Patent Application Publication
(10) Pub. No.: US 2023/0079934 A1
(43) Pub. Date: Mar. 16, 2023

(54) Control Device for Internal Combustion Engine

(71) Applicant: Hitachi Astemo, Ltd., Hitachinaka-shi, Ibaraki (JP)

(72) Inventors: Kazuhiro ORYOJI, Tokyo (JP); Yoshihiko AKAGI, Hitachinaka-shi (JP); Ryutaro KOIWAI, Tokyo (JP)

(21) Appl. No.: 17/793,550

(22) PCT Filed: Jan. 15, 2021
(86) PCT No.: PCT/JP2021/001178

§ 371 Date: Jul. 18, 2022

(30) Foreign Application Priority Data
Mar. 30, 2020 (JP) 2020-060879

(51) Int. Cl. F02P 5/15; F01N 3/20; F02P 5/04

(52) U.S. Cl. CPC F02P 5/1504; F01N 3/2006; F02P 5/045

(57) ABSTRACT

Provided is a control device of an internal combustion engine capable of increasing the temperature of a catalyst and the temperature of coolant more efficient1y than a conventional waste heat control device. A control device acquires a coolant temperature T_cw and a catalyst temperature T_cat of an exhaust system and controls an ignition timing θ of the internal combustion engine. The control device executes coolant heating control for increasing the energy distribution from the internal combustion engine to the coolant when the coolant temperature T_cw is equal to or less than a first threshold, and catalyst heating control for increasing the energy distribution from the internal combustion engine to the exhaust gas when the catalyst temperature T_cat is equal to or less than a second threshold.

### TECHNICAL FIELD

The present disclosure relates to a control device of an internal combustion engine.

### BACKGROUND ART

Conventionally, an invention related to a waste heat control device for an engine that controls a waste heat amount of the engine on the basis of a heat use request has been known (see PTL 1 below). The engine waste heat control device described in PTL 1 is applied to a waste heat reuse system that recovers and reuses waste heat of an engine, and controls the amount of waste heat of the engine on the basis of a required heat amount by a heat use request. The conventional waste heat control device includes an overlap amount control unit, an ignition control unit, and a waste heat control unit (Abstract, paragraph 0008, claim 1, and the like in the PTL 1).

An overlap amount control unit controls an overlap amount between an opening period of an intake valve and an opening period of an exhaust valve of the engine on the basis of an engine operation state. The ignition control unit controls the ignition timing of the engine at the maximum efficiency timing at which the maximum fuel consumption is achieved in each engine operation state. The waste heat control unit executes overlap increase control for changing the overlap amount to an increase side and ignition advance control for changing the ignition timing to an advance side from the highest efficiency timing corresponding to the overlap amount after the change to the increase side when the required heat amount is not satisfied.

As in the above configuration, the conventional waste heat control device changes the overlap amount to the increase side when the required heat amount cannot be satisfied, and changes the ignition timing to the advance side from the highest efficiency timing (MBT or the vicinity thereof) corresponding to the overlap amount after the change to the increase side. As a result, it is possible to perform waste heat control in accordance with the heat use request while suppressing fuel consumption deterioration as much as possible (paragraph 0009, etc. in the PTL 1).

### CITATION LIST

### Patent Literature

PTL 1: JP 2011-074800 A

### SUMMARY OF INVENTION

### Technical Problem

The conventional waste heat control device can obtain a certain effect when mainly recovering the waste heat of the engine by the coolant. However, the conventional waste heat control device has a problem that the operation frequency of the engine is low, and it is not possible to cope with a situation in which both the temperature of the catalyst included in the exhaust system of the engine and the temperature of the coolant are low.

The present disclosure provides a control device of an internal combustion engine capable of increasing the temperature of a catalyst and the temperature of coolant more efficient1y than the conventional waste heat control device as described above.

### Solution to Problem

One aspect of the present disclosure is a control device that acquires a coolant temperature and a catalyst temperature of an exhaust system and controls an ignition timing of an internal combustion engine. The control device executes: coolant heating control for increasing an energy distribution from the internal combustion engine to a coolant when the coolant temperature is equal to or lower than a first threshold; and catalyst heating control for increasing an energy distribution from the internal combustion engine to the exhaust gas when the catalyst temperature is equal to or lower than a second threshold.

### Advantageous Effects of Invention

According to the above aspect of the present disclosure, it is possible to provide a control device of an internal combustion engine capable of increasing the temperature of a catalyst and the temperature of coolant more efficient1y than a conventional waste heat control device.

### BRIEF DESCRIPTION OF DRAWINGS

FIG. 1 is a block diagram illustrating a first embodiment of a control device of an internal combustion engine according to the present disclosure.

FIG. 2 is a block diagram illustrating a relationship between the control device and the internal combustion engine of FIG. 1.

FIG. 3 is a block diagram illustrating a configuration of the control device of FIG. 1.

FIG. 4 is a functional block diagram of the control device of FIG. 1.

FIG. 5 is a graph for explaining energy distribution of the internal combustion engine of FIG. 1.

FIG. 6 is a flowchart for explaining processing by a function of calculating a correction amount of an ignition timing in FIG. 4.

FIG. 7 is a graph illustrating a state of the internal combustion engine in the processing of FIG. 6.

FIG. 8 is a flowchart for explaining a flow of processing of the control device in FIG. 1.

FIG. 9 is a graph illustrating a result of processing illustrated in FIG. 8.

FIG. 10 is a flowchart for explaining processing by a function of correcting the ignition timing of FIG. 4.

FIG. 11 is a graph for explaining energy distribution of the internal combustion engine by the processing of FIG. 10.

FIG. 12 is a functional block diagram illustrating a second embodiment of the control device of the internal combustion engine according to the present disclosure.

FIG. 13 is a flowchart for explaining processing by a function of correcting torque in FIG. 12.

FIG. 14 is a graph illustrating a result of the processing of FIG. 13.

FIG. 15 is a graph illustrating a result of the processing of FIG. 13.

FIG. 16 is a functional block diagram illustrating a third embodiment of the control device of the internal combustion engine according to the present disclosure.

FIG. 17 is a flowchart illustrating processing by a function of calculating distribution of ignition correction in FIG. 16.

FIG. 18 is a flowchart illustrating processing by a function of calculating an ignition correction amount in FIG. 16.

FIG. 19 is a graph illustrating results of the processing illustrated in FIGS. 17 and 18.

### DESCRIPTION OF EMBODIMENTS

Hereinafter, embodiments of a control device of an internal combustion engine according to the present disclosure will be described with reference to the drawings.

### First Embodiment

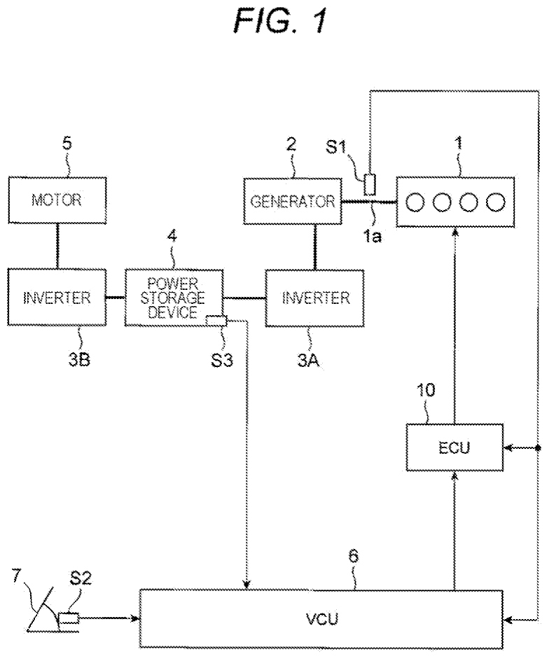

FIG. 1 is a block diagram illustrating a first embodiment of a control device of an internal combustion engine according to the present disclosure. A control device 10 according to the present embodiment is mounted on a vehicle such as a series hybrid vehicle, for example, and controls an engine 1 as an internal combustion engine.

The vehicle includes, for example, the engine 1, a generator 2, inverters 3A and 3B, a power storage device 4, a motor 5, a vehicle control device 6, an accelerator pedal 7, and the control device 10 of the internal combustion engine. The vehicle includes, for example, a crank angle sensor S1, an accelerator opening sensor S2, and a battery voltage sensor S3. The engine 1 is, for example, a spark ignition engine, and is, for example, a four-cylinder gasoline engine. The generator 2 is connected to a crankshaft la of the engine 1 and generates electric power by rotation of the crankshaft la.

For example, the power storage device 4 is connected to a generator via the inverter 3A, and is connected to the motor 5 via the inverter 3B. The power storage device 4 includes, for example, a plurality of secondary batteries, and is charged with generated power supplied from the generator 2 via the inverter 3A or regenerative power supplied from the motor 5 via the inverter 3B. The power storage device 4 supplies electric power to the motor 5 via the inverter 3B to drive the motor 5. The motor 5 is driven by electric power supplied from the power storage device 4 via the inverter 3B, and rotates wheels (not illustrated) to drive the vehicle.

The vehicle control device 6 is connected to the crank angle sensor S1, the accelerator opening sensor S2, the battery voltage sensor S3, and the control device 10 of the internal combustion engine so as to be able to communicate information. The crank angle sensor S1 detects a rotation angle of the crankshaft la of the engine 1. The accelerator opening sensor S2 detects a depression amount of the accelerator pedal 7, that is, an accelerator opening degree. The battery voltage sensor S3 measures an internal voltage of the power storage device 4. The vehicle control device 6 receives signals of a detection result and a measurement result from the sensors S1, S2, and S3.

The vehicle control device 6 calculates required torque based on the operation of the driver of the vehicle on the basis of the detection result of the accelerator opening degree input from the accelerator opening sensor S2. That is, the accelerator opening sensor S2 can be used as required torque sensor that detects required torque for the engine 1 or the motor 5. The vehicle control device 6 calculates a state of charge or a charged remaining power amount of the power storage device 4 on the basis of the detection result of the internal voltage of the power storage device 4 input from the battery voltage sensor S3. The vehicle control device 6 calculates the rotation speed of the engine 1 on the basis of the detection result of the rotation angle of the crankshaft la input from the crank angle sensor S1.

Further, the vehicle control device 6 calculates an optimum operation amount of each device such as the required output of the engine 1 and the required output of the power storage device 4 on the basis of the required torque based on the input from each of the sensors S1, S2, and S3 and the operation state of the vehicle. The vehicle control device 6 outputs a control signal including the calculated required output of the engine 1 to the control device 10 of the internal combustion engine. The control device 10 of the internal combustion engine controls the engine 1 on the basis of the control signal including the required output of the engine 1 input from the vehicle control device 6.

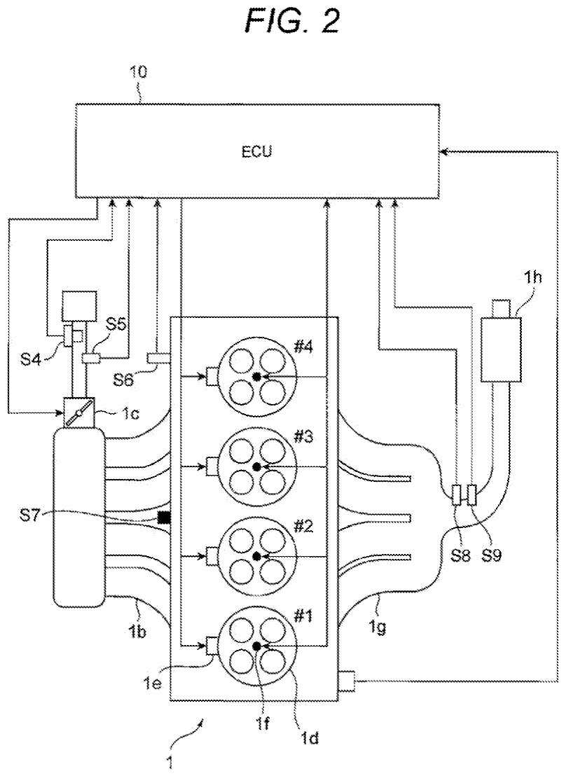

FIG. 2 is a block diagram illustrating a relationship between the control device 10 of the internal combustion engine of FIG. 1 and the engine 1 as the internal combustion engine to be controlled.

In addition to the crankshaft la and the crank angle sensor S1 of FIG. 1, the engine 1 includes, for example, an intake pipe 1b, an air flow sensor S4, an electronically controlled thrott1e 1c, and an intake temperature sensor S5 as illustrated in FIG. 2. The engine 1 includes, for example, four cylinders 1d, an injector 1e, an ignition coil 1f, a coolant temperature sensor S6, and a knock sensor S7. The engine 1 includes, for example, an exhaust pipe 1g, a three-way catalyst 1h, an air-fuel ratio sensor S8, and an exhaust gas temperature sensor S9.

For example, the intake pipe 1b circulates air flowing into each cylinder 1d of the engine 1. The air flow sensor S4 is provided, for example, at an appropriate position of the intake pipe 1b, measures the flow rate of air flowing through the intake pipe 1b, and outputs the measurement result to the control device 10. The electronically controlled thrott1e 1c is controlled by the control device 10, for example, and adjusts the flow rate of air flowing into each cylinder 1d. The intake temperature sensor S5 measures, for example, the temperature of air flowing through the intake pipe 1b, and outputs the measurement result to the control device 10.

The injector 1e is, for example, a fuel injection device or an in-cylinder direct injection injector that is provided in each cylinder 1d (#1 to #4) and injects fuel into a combustion chamber of each cylinder 1d. The ignition coil if generates, for example, a high voltage for discharging with an ignition plug provided in each cylinder 1d. The coolant temperature sensor S6 is provided, for example, at an appropriate position of the cylinder head of the engine 1, measures the coolant temperature of the engine 1, and outputs the measurement result to the control device 10. The knock sensor S7 is provided, for example, in a cylinder block of the engine 1, detects vibration of the engine 1, and outputs the detection result to the control device 10.

For example, the exhaust pipe 1g circulates exhaust gas discharged from each cylinder of the engine 1. The three-way catalyst 1h is provided at an appropriate position of the exhaust pipe 1g, for example, and purifies the exhaust gas flowing through the exhaust pipe lg. The air-fuel ratio sensor S8 is provided, for example, on the upstream side of the three-way catalyst 1h in the exhaust pipe 1g in the exhaust flow, measures the air-fuel ratio of the exhaust, and outputs the measurement result to the control device 10. The exhaust gas temperature sensor S9 is provided, for example, on the upstream side of the three-way catalyst 1h in the exhaust pipe 1g in the exhaust flow, measures the exhaust temperature, and outputs the measurement result to the control device 10.

The control device 10 of the internal combustion engine of the present embodiment is, for example, an electronic control device (ECU) including a processing device such as a CPU, a storage device such as a memory, a signal input/output unit, and the like. The control device 10 receives the measurement results from, for example, the crank angle sensor S1, the air flow sensor S4, the intake temperature sensor S5, the coolant temperature sensor S6, the knock sensor S7, the air-fuel ratio sensor S8, and the exhaust gas temperature sensor S9 described above. The control device 10 receives the measurement result of the accelerator opening sensor S2 via the above-described vehicle control device 6, for example.

In the control device 10, the required torque of the engine 1 calculated by the vehicle control device 6 on the basis of the measurement result of the accelerator opening sensor S2 is input from the vehicle control device 6. In the control device 10, the rotation speed of the engine 1 calculated by the vehicle control device 6 on the basis of the measurement result of the crank angle sensor S1 is input from the vehicle control device 6. The required torque and the rotation speed of the engine 1 can also be calculated by the control device 10 on the basis of the measurement result of the accelerator opening sensor S2 and the measurement result of the crank angle sensor S1, respectively.

The control device 10 calculates the operation state of the engine 1 on the basis of, for example, the information input from each of the above-described sensors. The control device 10 calculates main control parameters of the engine 1 including an ignition timing, a thrott1e opening degree, a fuel injection amount, and the like of the engine 1.

The fuel injection amount calculated by the control device 10 is converted into, for example, a valve opening pulse signal, and is output from the control device 10 to the injector le. The ignition timing calculated by the control device 10 is converted into, for example, an ignition signal and output from the control device 10 to the ignition coil lf. The thrott1e opening degree calculated by the control device 10 is converted into a thrott1e drive signal and output from the control device 10 to the electronically controlled thrott1e 1c.

The electronically controlled thrott1e 1c allows air to pass at a thrott1e opening degree according to the thrott1e drive signal input from the control device 10. The air that has passed through the electronically controlled thrott1e 1c flows through the intake pipe 1b and flows into the combustion chamber of each cylinder 1d via an intake valve (not illustrated). The injector 1e injects fuel into the combustion chamber of each cylinder 1d according to the valve opening pulse signal input from the control device 10. As a result, an air-fuel mixture is generated in the combustion chamber of each cylinder 1d.

The ignition coil if generates a high voltage for discharging by the ignition plug according to the ignition signal input from the control device 10. As a result, the air-fuel mixture is combusted in the combustion chamber of each cylinder 1d, the piston in each cylinder 1d (not illustrated) is pushed down, a driving force is generated in the engine 1, and the crankshaft la rotates. The exhaust gas discharged from the combustion chamber of each cylinder 1d after the combustion of the air-fuel mixture flows through the exhaust pipe 1g, is purified by the three-way catalyst 1h, and is discharged to the outside.

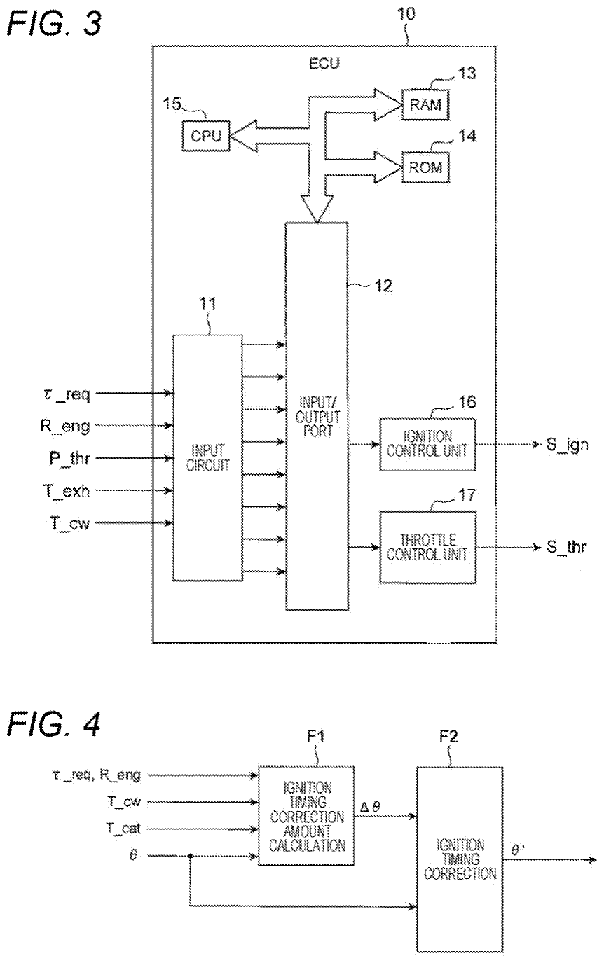

FIG. 3 is a block diagram illustrating an example of a configuration of the control device 10 of the internal combustion engine of FIG. 1. The control device 10 includes, for example, an input circuit 11, an input/output port 12, a RAM 13, a ROM 14, a CPU 15, an ignition control unit 16, and a thrott1e control unit 17.

For example, required torque τ_req and a rotation speed R_eng of the engine 1 calculated by the vehicle control device 6 and output from the vehicle control device 6 are input to the input circuit 11. In the input circuit 11, for example, a thrott1e opening degree P_thr is input from the electronically controlled thrott1e 1c, an exhaust temperature T_exh is input from the exhaust gas temperature sensor S9, and a coolant temperature T_cw is input from the coolant temperature sensor S6.

Although not illustrated in FIG. 3, in the input circuit 11, for example, the air flow rate is input from the air flow sensor S4, the intake air temperature is input from the intake temperature sensor S5, the detection result of the vibration of the engine 1 is input from the knock sensor S7, and the air-fuel ratio is input from the air-fuel ratio sensor S8. In this manner, information other than the information illustrated in FIG. 3 may be input to the input circuit 11. The input circuit 11 outputs the input information to the input port of the input/output port 12.

The RAM 13 acquires information output from the input circuit 11 via the input/output port 12 and temporarily holds the information. The ROM 14 stores various control programs and data.

The CPU 15 executes various control programs stored in the ROM 14 to execute various arithmetic processing using the information stored in the RAM 13. Through the various types of arithmetic processing, the CPU 15 calculates various control parameters including the operation amounts of the various actuators of the vehicle, and causes the RAM 13 to hold the control parameters.

Further, the CPU 15 outputs various control parameters held in the RAM 13 to various drive circuits including the ignition control unit 16 and the thrott1e control unit 17 via the output port of the input/output port 12. The control device 10 may include a drive circuit other than the ignition control unit 16 and the thrott1e control unit 17. These drive circuits may be installed outside the control device 10.

The ignition control unit 16 outputs an ignition signal S_ign to the ignition coil if on the basis of the control parameter input via the output port of the input/output port 12. The thrott1e control unit 17 outputs a control signal S_thr of the thrott1e opening degree to the electronically controlled thrott1e 1c on the basis of the control parameter input via the output port of the input/output port 12.

The CPU 15 detects the occurrence of knocking by executing arithmetic processing using the detection result of the vibration of the engine 1 input from the knock sensor S7 to the input circuit 11 and held in the RAM 13 via the input/output port 12. The CPU 15 estimates the temperature of the three-way catalyst 1h in the exhaust system, that is, a catalyst temperature T_cat by executing arithmetic processing using the exhaust temperature T_exh input from the exhaust gas temperature sensor S9 to the input circuit 11 and held in the RAM 13 via the input/output port 12.

FIG. 4 is a functional block diagram of the control device 10 of the internal combustion engine of FIG. 1. The control device 10 has, for example, a function F1 of calculating an ignition timing correction amount Δθ and a function F2 of correcting the ignition timing. The functions F1 and F2 of the control device 10 can be realized, for example, by executing a control program stored in the ROM 14 by the CPU 15.

The function F1 of calculating the ignition timing correction amount Δθ uses, for example, the required torque τ_req and the rotational speed R_eng of the engine 1, the coolant temperature T_cw, the catalyst temperature T_cat, and an ignition timing θ as inputs. The function F1 calculates the ignition timing correction amount Δθ on the basis of these inputs.

The function F2 of correcting the ignition timing uses, for example, the ignition timing θ and the ignition timing correction amount Δθ as inputs, and calculates a corrected ignition timing θ.

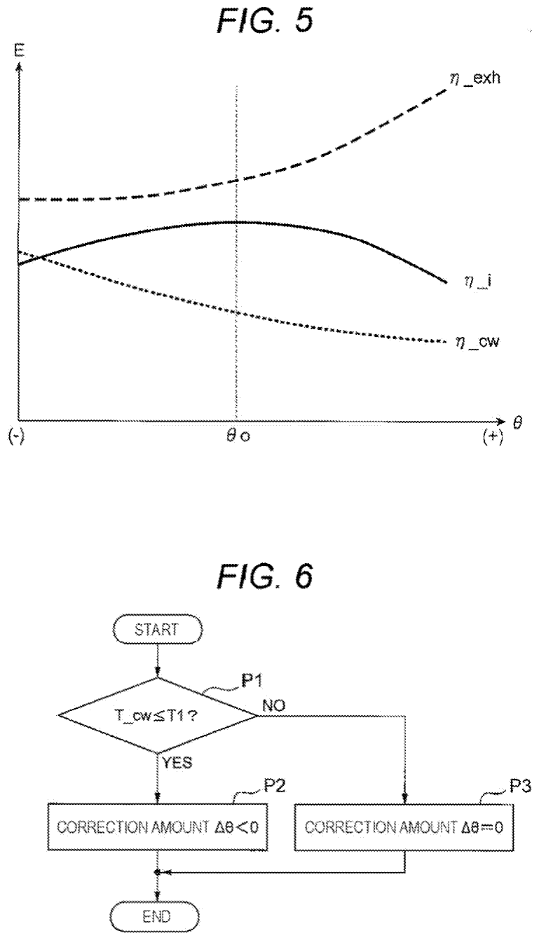

FIG. 5 is a graph for explaining energy distribution of the engine 1 as the internal combustion engine of FIG. 1. In the graph of FIG. 5, the vertical axis represents energy E, and the horizontal axis represents the ignition timing θ of the engine 1.

In FIG. 5, an energy distribution η_cw from the engine 1 to the coolant is indicated by a dotted line, an energy distribution η_exh from the engine 1 to the exhaust gas is indicated by a broken line, and an energy distribution η_i to the power of the engine 1 is indicated by a solid line. The energy distributions η_i, η_cw, and η_exh are, for example, ratios to the total energy generated by the engine 1.

Here, advancing the ignition timing θ of the engine 1 is synonymous with decreasing the crank angle at the ignition timing θ. Retarding the ignition timing θ of the engine 1 is synonymous with increasing the crank angle at the ignition timing θ. Therefore, hereinafter, the correction of the ignition timing θ in which the ignition timing correction amount Δθ becomes negative is referred to as advance correction, and the correction of the ignition timing θ in which the ignition timing correction amount Δθ becomes positive is referred to as retardation correction.

The energy distribution η_i to the power of the engine 1 becomes maximum at an optimum ignition timing θo, and decreases when the ignition timing θ is corrected to advance or retard from the optimum ignition timing θo. The energy distribution η_cw from the engine 1 to the coolant increases as the ignition timing correction amount Δθ of the advance correction increases. The energy distribution η_exh from the engine 1 to the exhaust gas increases as the correction amount of the retardation correction increases. That is, in the engine 1, the energy distributions η_i, η_cw, and η_exh to the power, the coolant, and the exhaust gas change depending on the ignition timing θ.

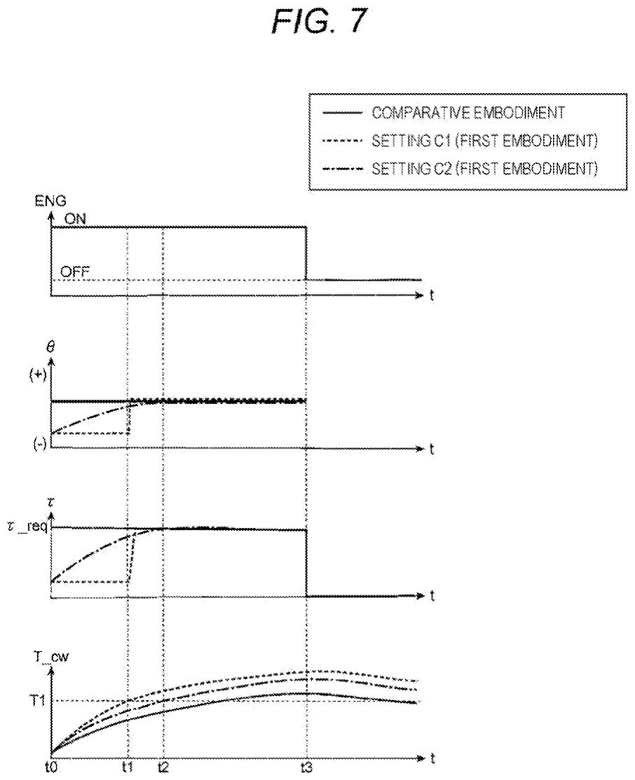

FIG. 6 is a flowchart for explaining arithmetic processing by the function F1 of calculating the ignition timing correction amount Δθ in FIG. 4. FIG. 7 is a graph illustrating the state of the engine 1 in the processing flow of FIG. 6.

In FIG. 7, the horizontal axes of the graphs are all time t, and the vertical axes of the graphs are the on and off states of the engine 1, the ignition timing θ, the torque τ of the engine 1, and the coolant temperature T_cw in order from top to bottom. In each of the graphs excluding the graph indicating on and off of the engine 1 in FIG. 7, the states of the engine 1 in the comparative embodiment using the conventional control device and a setting C1 and a setting C2 of the advance control by the control device 10 of the present embodiment are indicated by a solid line, a dotted line, and a chain line.

As illustrated in FIG. 7, when the required torque τ_req is input at time t0, the engine 1 is started and turned on. Here, in order to facilitate understanding of the operation of the engine 1, a case where the required torque τ_req is constant will be described. In the comparative embodiment using the conventional control device, when the engine 1 is started at time t0, the thrott1e opening degree P_thr and the ignition timing θ are set so as to satisfy the required torque τ_req.

As a result, in the graph of the ignition timing θ and the graph of a torque target value τ of FIG. 7, in the comparative embodiment indicated by the solid line, the ignition timing θ and the torque τ are maintained approximately constant. In the ON state in which the engine 1 is operating, energy is supplied as heat from the engine 1 to the coolant. Accordingly, in the graph of the coolant temperature T_cw in FIG. 7, in the comparative embodiment indicated by the solid line, the coolant temperature T_cw gradually increases.

On the other hand, when the engine 1 is started at time t0, the control device 10 of the present embodiment starts the processing flow illustrated in FIG. 6 by the function F1 of calculating the ignition timing correction amount Δθ of FIG. 4. The function F1 first executes a process P1 for determining whether the coolant temperature T_cw is equal to or lower than a first threshold T1 that is a predetermined temperature threshold. In the process P1, when determining that the coolant temperature T_cw is equal to or lower than the first threshold T1 (YES), the function F1 executes the next process P2.

In the process P2, the control device 10 executes coolant heating control for increasing the energy distribution η_cw from the engine 1, which is an internal combustion engine, to the coolant. For example, the control device 10 executes the advance control for advancing the ignition timing θ in the coolant heating control. More specifically, the control device 10 sets the ignition timing correction amount Δθ to a negative value by the function F1, for example. Here, for the setting of the ignition timing correction amount Δθ, for example, the following setting C1 and setting C2 can be selected.

In the setting C1, for example, the ignition timing correction amount Δθ is set to a predetermined negative fixed value. In the setting C2, for example, the ignition timing correction amount Δθ is set so as to have a correlation with a coolant temperature deviation ΔT_cw. Here, the coolant temperature deviation ΔT_cw is, for example, a difference between the coolant temperature T_cw and the first threshold Tl which is a predetermined temperature threshold. More specifically, in the setting C2, the ignition timing correction amount Δθ can be set as, for example, the following Expression (1) or (2).

Δθ=A×(T1−T_cw)+Δθas(T_cw<T1) (1)

Δθ=Δθas(T_cw≥T1) (2)

In the above Expressions (1) and (2), A is a positive constant, and Δθas is a reference advance correction amount. In this setting C2, by setting the ignition timing correction amount Δθ as in the above (1) and (2), a negative correlation can be given between the ignition timing correction amount Δθ and the coolant temperature deviation ΔT_cw. In other words, in the setting C2, the ignition timing correction amount Δθ (absolute value), which is the correction amount of the advance correction, increases as the coolant temperature deviation ΔT_cw increases.

In the advance correction, the ignition timing correction amount Δθ becomes a negative value. Therefore, increasing the ignition timing correction amount Δθ as the advance correction amount is synonymous with increasing the absolute value of the ignition timing correction amount Δθ. The reference advance correction amount Δθas can be determined on the basis of, for example, a map created by performing an experiment or simulation using the engine 1 in advance and acquiring parameters such as the coolant temperature T_cw and the operating conditions. The reference advance correction amount Deas can be set to a negative value.

As described above, the function F1 of calculating the ignition timing correction amount Δθ of the control device 10 executes the advance control for advancing the ignition timing in the coolant heating control executed in the process P2. In the advance control executed in the process P2, when the setting C2 is selected, the function F1 increases the ignition timing correction amount Δθ as the advance correction amount for advancing the ignition timing e as the difference between the first threshold T1 and the coolant temperature T_cw increases.

As described above, in the process P2 illustrated in FIG. 6, the function F1 of calculating the ignition timing correction amount Δθ in FIG. 4 sets the negative ignition timing correction amount Δθ according to, for example, the setting such as the setting C1 or the setting C2, and outputs the negative ignition timing correction amount Δθ to the function F2 of correcting the ignition timing. As a result, the process illustrated in FIG. 6 ends, and the function F2 of correcting the ignition timing in FIG. 4 calculates the corrected ignition timing θ′ on the basis of the ignition timing correction amount Δθ input from the function F1 and the latest ignition timing θ.

The corrected ignition timing θ calculated by the function F2 of correcting the ignition timing of the control device 10 is converted into the ignition signal S_ign by the ignition control unit 16 illustrated in FIG. 2 and output to the ignition coil if illustrated in FIG. 2. As a result, as illustrated in FIG. 5, for example, the ignition timing θ of the engine 1 is advanced from the optimum ignition timing θo, and the energy distribution η_cw from the engine 1, which is an internal combustion engine, to the coolant increases.

As a result, in the setting C1 in which the ignition timing correction amount Δθ is set to a predetermined negative fixed value, as indicated by a dotted line in the graph of the ignition timing θ in FIG. 7, for example, the ignition timing θ is corrected to a negative constant value from time t0 to time t1, and the torque τ decreases. As indicated by a dotted line in the graph of the coolant temperature T_cw in FIG. 7, in the setting C1 of the present embodiment, the coolant temperature T_cw can be increased earlier than in the comparative embodiment indicated by a solid line.

In the setting C2, the ignition timing correction amount Δθ as the advance correction amount is increased as the coolant temperature deviation ΔT_cw is increased. As a result, as indicated by a chain line in the graph of the ignition timing θ in FIG. 7, for example, the ignition timing θ gradually advances from time t0 to time t2 so as to approach the optimum ignition timing θo, and the ignition timing correction amount Δθ as the advance correction amount gradually decreases. As indicated by a chain line in the graph of the torque τ, the torque τ gradually increases from a value lower than the required torque τ_req so as to approach the required torque τ_req. As indicated by a chain line in the graph of the coolant temperature T_cw, in the setting C2 of the present embodiment, the coolant temperature T_cw can be increased earlier than in the comparative embodiment indicated by the solid line.

The coolant temperature T_cw increases by the setting C1 of the advance control of the present embodiment indicated by a dotted line in the graph of the coolant temperature T_cw in FIG. 7, and exceeds the first threshold T1 at time t1, for example. The coolant temperature T_cw increases due to the setting C2 of the advance control of the present embodiment indicated by a chain line in the graph, and exceeds the first threshold T1 at time t2, for example. Then, in the process P1 illustrated in FIG. 6, the function F1 of calculating the ignition timing correction amount Δθ illustrated in FIG. 4 determines that the coolant temperature T_cw is not equal to or less than the first threshold T1 (NO), and the function F1 executes the next process P3.

In the process P3, the function F1 sets the ignition timing correction amount Δθ to zero, and ends the processing flow illustrated in FIG. 6. Thereafter, the function F2 of correcting the ignition timing in FIG. 4 calculates the corrected ignition timing θ′ on the basis of the ignition timing correction amount Δθ input from the function F1 and the latest ignition timing θ. In this case, the ignition timing θ is not corrected, and the ignition timing θ′ calculated by the function F2 is equal to the latest ignition timing θ.

As a result, as indicated by a dotted line in the graph of the ignition timing θ in FIG. 7, in the setting C1 of the advance control of the present embodiment, the ignition timing correction amount Δθ becomes zero after time t1. As indicated by a chain line in the graph, in the setting C2 of the advance control of the present embodiment, the ignition timing correction amount Δθ becomes zero after time t2. As a result, the ignition timing θ illustrated in FIG. 5 does not change from, for example, the optimum ignition timing θo, and the energy distributions η_i, η_cw, and η_exh to the power of the engine 1, the coolant, and the exhaust gas become substantially constant ratios.

As a result, as illustrated in FIG. 7, the rate of increase in the coolant temperature T_cw is also substantially constant. Thereafter, for example, at time t3, the engine 1 is turned off, the operation of the engine 1 is stopped, and the control of the engine 1 by the control device 10 ends.

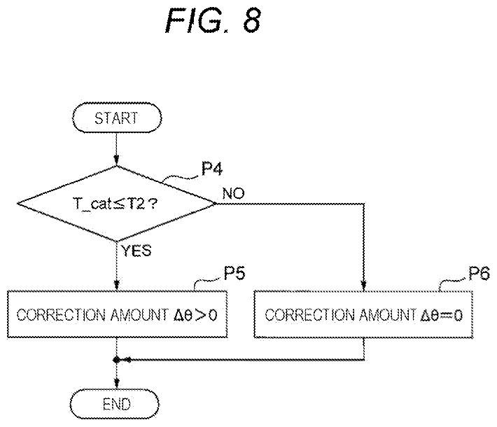

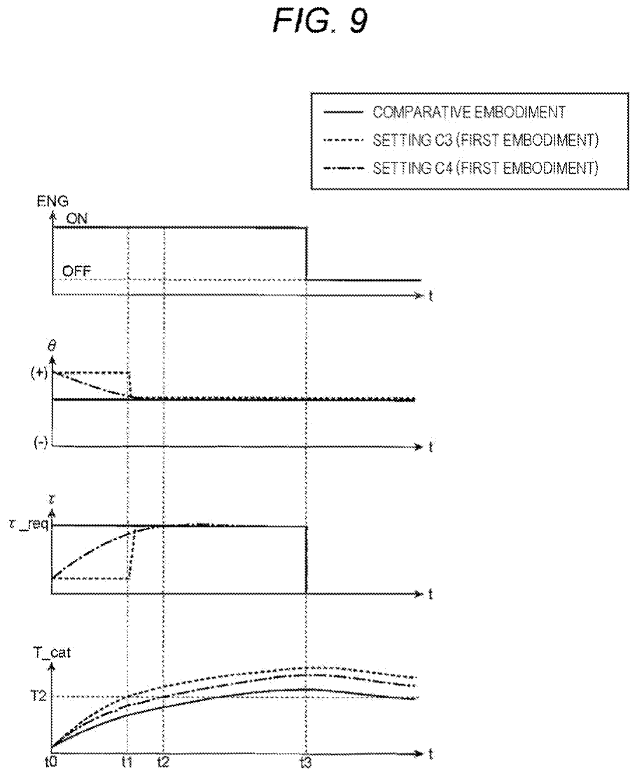

FIG. 8 is a flowchart for explaining arithmetic processing by the function F1 of calculating the ignition timing correction amount Δθ in FIG. 4. FIG. 9 is a graph illustrating the state of the engine 1 in the processing flow of FIG. 8.

The horizontal axis and the vertical axis of each graph in FIG. 9 are the same as those of each graph in FIG. 7 described above except for the vertical axis of the lowest graph. The vertical axis of the bottom graph of FIG. 9 is the catalyst temperature T_cat. In each of the graphs excluding the graph indicating on and off of the engine 1 in FIG. 9, the states of the engine 1 in the comparative embodiment using the conventional control device and the setting C3 and the setting C4 of retardation control by the control device 10 of the present embodiment are indicated by a solid line, a dotted line, and a chain line.

As illustrated in FIG. 9, when the required torque τ_req is input at time t0, the engine 1 is started and turned on. Here, in order to facilitate understanding of the operation of the engine 1, a case where the required torque τ_req is constant will be described. In the comparative embodiment using the conventional control device, when the engine 1 is started at time t0, the thrott1e opening degree P_thr and the ignition timing θ are set so as to satisfy the required torque τ_req.

As a result, in the graph of the ignition timing θ and the graph of the torque target value i in FIG. 9, in the comparative embodiment indicated by the solid line, the ignition timing θ and the torque τ are maintained approximately constant. In the ON state in which the engine 1 is operating, energy is supplied as heat from the engine 1 to the exhaust gas. As a result, in the comparative embodiment indicated by the solid line in the graph of the catalyst temperature T_cat in FIG. 9, the catalyst temperature T_cat gradually increases. The catalyst temperature T_cat can be estimated on the basis of the exhaust temperature T_exh, for example, as described above.

On the other hand, when the engine 1 is started at time t0, the control device 10 of the present embodiment starts the processing flow illustrated in FIG. 8 by the function F1 of calculating the ignition timing correction amount Δθ of FIG. 4. The function F1 first executes a process P4 for determining whether the catalyst temperature T_cat is equal to or less than a second threshold T2 which is a threshold of a predetermined temperature. In the process P4, when determining that the catalyst temperature T_cat is equal to or lower than the second threshold T2 (YES), the function F1 executes the next process P5.

In the process P5, the control device 10 executes catalyst heating control for increasing the energy distribution η_exh from the engine 1, which is an internal combustion engine, to the exhaust gas. For example, the control device 10 executes retardation control for delaying the ignition timing θ in the catalyst heating control. More specifically, the control device 10 sets the ignition timing correction amount Δθ to a positive value by the function F1, for example. Here, for the setting of the ignition timing correction amount Δθ, for example, the following setting C3 and setting C4 can be selected.

In the setting C3, for example, the ignition timing correction amount Δθ is set to a predetermined positive fixed value. In the setting C4, for example, the ignition timing correction amount Δθ is set to have correlation with a catalyst temperature deviation ΔT_cat. Here, the catalyst temperature deviation ΔT_cat is, for example, a difference between the catalyst temperature T_cat and the second threshold T2 which is a predetermined temperature threshold. More specifically, in the setting C4, the ignition timing correction amount Δθ can be set as, for example, the following Expression (3) or (4).

Δθ=B×(T2−T_cat)+Δθds(T_cat<T2) (3)

Δθ=Δθds(T_cat>T2) (4)

In the above Expressions (3) and (4), B is a positive constant, and Aeds is a reference retardation correction amount. In this setting C4, by setting the ignition timing correction amount Δθ as in the above (3) and (4), a positive correlation can be given between the ignition timing correction amount Δθ and the catalyst temperature deviation ΔT_cat. In other words, in the setting C2, the ignition timing correction amount Δθ, which is the correction amount of the retardation correction, increases as the catalyst temperature deviation ΔT_cat increases.

In the retardation correction, the ignition timing correction amount Δθ is a positive value. Therefore, increasing the ignition timing correction amount Δθ as the retardation correction amount is synonymous with increasing the ignition timing correction amount Δθ. The reference retardation correction amount Δθds can be determined on the basis of a map created by, for example, acquiring parameters such as the catalyst temperature T_cat and the operation condition by performing an experiment or simulation using the engine 1 in advance. The reference retardation correction amount Δθds can be set to a positive value.

As described above, the function F1 of calculating the ignition timing correction amount Δθ of the control device 10 executes the retardation control for delaying the ignition timing in the catalyst heating control executed in the process P5. In the retardation control executed in the process P5, when the setting C4 is selected, the function F1 increases the ignition timing correction amount Δθ as a retardation correction amount for delaying the ignition timing θ as the difference between the second threshold T2 and the catalyst temperature T_cat increases.

As described above, in the process P5 illustrated in FIG. 8, the function F1 of calculating the ignition timing correction amount Δθ in FIG. 4 sets the positive ignition timing correction amount Δθ according to, for example, the setting such as the setting C3 or the setting C4, and outputs the positive ignition timing correction amount Δθ to the function F2 of correcting the ignition timing. As a result, the process illustrated in FIG. 8 ends, and the function F2 of correcting the ignition timing in FIG. 4 calculates the corrected ignition timing θ′ on the basis of the ignition timing correction amount Δθ input from the function F1 and the latest ignition timing θ.

The corrected ignition timing θ′ calculated by the function F2 of correcting the ignition timing of the control device 10 is converted into the ignition signal S_ign by the ignition control unit 16 illustrated in FIG. 2 and output to the ignition coil if illustrated in FIG. 2. As a result, as illustrated in FIG. 5, for example, the ignition timing θ of the engine 1 is retarded from the optimum ignition timing θo, and the energy distribution η_exh from the engine 1, which is an internal combustion engine, to the exhaust gas is increased.

As a result, in the setting C3 in which the ignition timing correction amount Δθ is set to a predetermined positive fixed value, as indicated by a dotted line in the graph of the ignition timing θ in FIG. 9, for example, the ignition timing θ is corrected to a positive constant value from time t0 to time t1, and the torque τ decreases. As indicated by a dotted line in the graph of the catalyst temperature T_catw in FIG. 9, in the setting C3 of the present embodiment, the catalyst temperature T_cat can be increased earlier than in the comparative embodiment indicated by a solid line.

In the setting C4, the ignition timing correction amount Δθ as the retardation correction amount is increased as the catalyst temperature deviation ΔT_cat is increased. As a result, as indicated by a chain line in the graph of the ignition timing θ in FIG. 9, for example, the ignition timing θ gradually advances from time t0 to time t2 so as to approach the optimum ignition timing θo, and the ignition timing correction amount A as the retardation correction amount gradually decreases. As indicated by a chain line in the graph of the torque τ, the torque τ gradually increases from a value lower than the required torque τ_req so as to approach the required torque τ_req. As indicated by a chain line in the graph of the catalyst temperature T_cat, in the setting C4 of the present embodiment, the catalyst temperature T_cat can be increased earlier than in the comparative embodiment indicated by the solid line.

The catalyst temperature T_cat increases by the setting C3 of the retardation control of the present embodiment indicated by a dotted line in the graph of the catalyst temperature T_cat of FIG. 9, and exceeds the second threshold T2 at time t1, for example. The catalyst temperature T_cat increases by the setting C4 of the retardation control of the present embodiment indicated by a chain line in the graph, and exceeds the second threshold T2 at time t2, for example. Then, in the process P1 illustrated in FIG. 8, the function F1 of calculating the ignition timing correction amount Δθ illustrated in FIG. 4 determines that the catalyst temperature T_cat is not equal to or less than the second threshold T2 (NO), and the function F1 executes the next process P6.

In the process P6, the function F1 sets the ignition timing correction amount Δθ to zero, and ends the processing flow illustrated in FIG. 8. Thereafter, the function F2 of correcting the ignition timing in FIG. 4 calculates the corrected ignition timing θ′ on the basis of the ignition timing correction amount Δθ input from the function F1 and the latest ignition timing θ. In this case, the ignition timing θ is not corrected, and the ignition timing θ′ calculated by the function F2 is equal to the latest ignition timing θ.

As a result, as indicated by a dotted line in the graph of the ignition timing θ in FIG. 9, in the retardation control setting C3 of the present embodiment, the ignition timing correction amount Δθ becomes zero after time t1. As indicated by a chain line in the graph, in the setting C4 of the retardation control of the present embodiment, the ignition timing correction amount Δθ becomes zero after time t2. As a result, the ignition timing θ illustrated in FIG. 5 does not change from, for example, the optimum ignition timing θo, and the energy distributions η_i, η_cw, and η_exh to the power of the engine 1, the coolant, and the exhaust gas become substantially constant ratios.

As a result, as illustrated in FIG. 9, the rate of increase in the catalyst temperature T_cat is also substantially constant. Thereafter, for example, at time t3, the engine 1 is turned off, the operation of the engine 1 is stopped, and the control of the engine 1 by the control device 10 ends.

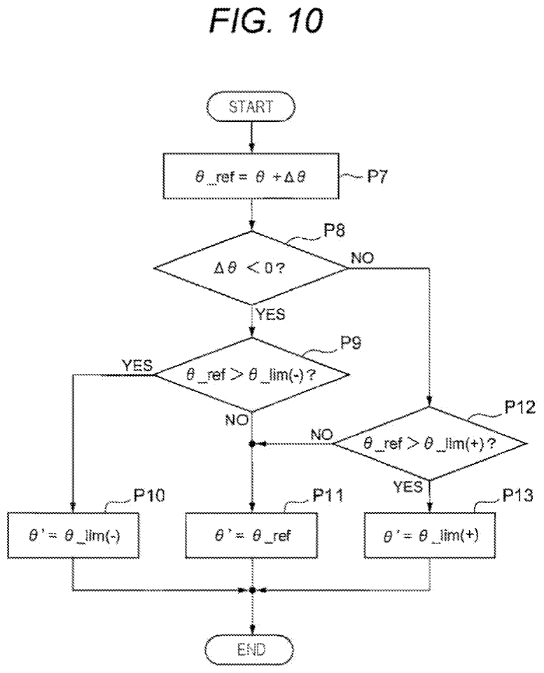

FIG. 10 is a flowchart for explaining an example of processing by the function F2 of correcting the ignition timing in FIG. 4. As described above, the function F2 of correcting the ignition timing uses the current ignition timing θ and the ignition timing correction amount Δθ set by the function F1 of calculating the ignition timing correction amount Δθ as inputs. When the processing flow illustrated in FIG. 10 is started, the function F2 first executes a process P7 for setting the sum of the ignition timing θ and the ignition timing correction amount Δθ to an ignition timing reference value θ_ref.

Next, the function F2 executes a process P8 for determining whether the ignition timing correction amount Δθ is negative. In this process P8, when determining that the ignition timing correction amount Δθ is negative (YES), the function F2 executes a process P9 for determining whether the ignition timing reference value θ_ref is larger than an advance limit value θ_lim(−). The setting of the advance limit value θ_lim(−) will be described later.

In this process P9, when determining that the ignition timing reference value θ_ref is larger than the advance limit value θ_lim(−) (YES), the function F2 executes a process P10 for setting the corrected ignition timing θ′ to the advance limit value θ_lim(−), and ends the processing flow illustrated in FIG. 10. On the other hand, in the process P9, when determining that the ignition timing reference value θ_ref is equal to or less than the advance limit value θ_lim(−) (NO), the function F2 executes a process Pll for setting the corrected ignition timing θ′ to the ignition timing reference value θ_ref, and ends the processing flow illustrated in FIG. 10.

When determining that the ignition timing correction amount Δθ is 0 or more (NO) in the process P8 described above, the function F2 executes a process P12 for determining whether the ignition timing reference value θ_ref is larger than a retardation limit value θ_lim(+). In this process P12, when determining that the ignition timing reference value θ_ref is equal to or less than the retardation limit value θ_lim(+) (NO), the function F2 executes the process P11 for setting the corrected ignition timing θ′ to the ignition timing reference value θ ref, and ends the processing flow illustrated in FIG. 10.

On the other hand, in the process P12, when determining that the ignition timing reference value θ_ref is larger than the retardation limit value θ_lim(+) (YES), the function F2 executes a process P13 for setting the corrected ignition timing θ′ to the retardation limit value θ_lim(+), and ends the processing flow illustrated in FIG. 10.

Here, the setting of the advance limit value θ_lim(−) will be described. The advance limit value θ_lim(−) is a limit value of the ignition timing θ when the ignition timing θ is advanced, and is set on the basis of, for example, the ignition timing θ at which abnormal combustion occurs in the engine 1.

More specifically, for example, the ignition timing θ at which the abnormal combustion occurs is mapped according to the operating conditions such as the torque τ and the rotation speed of the engine 1 and the coolant temperature T_cw. Then, the advance limit value θ_lim(−) at which the abnormal combustion does not occur is set on the basis of the ignition timing θ at which the abnormal combustion occurs, the ignition timing θ being derived from the map using the actual operating conditions and the coolant temperature T_cw.

When the map as described above is not used, for example, the ignition timing θ at which abnormal combustion occurs may be calculated by the function F2 of correcting the ignition timing of the control device 10 from the relationship between the detection result of the knock sensor S7 and the ignition timing θ. In this case, the function F2 sets the advance limit value θ_lim(−) at which the abnormal combustion does not occur on the basis of the calculated ignition timing θ at which the abnormal combustion occurs.

When the torque τ of the engine 1 is smaller than friction torque for operating the engine 1, the engine 1 cannot be operated. Therefore, the advance limit value θ_lim(−) of the advance control is set on the basis of the range in which the rotation of the engine 1 as the internal combustion engine can be continued. That is, when the torque τ of the engine 1 is small and the difference between the torque τ of the engine and the friction torque is smaller than a predetermined value, the advance limit value θ_lim(−) is set on the basis of the relationship between the torque τ of the engine 1 and the friction torque.

More specifically, for example, the friction torque is mapped according to the operating condition of the engine 1 and the coolant temperature T_cw. Then, friction torque τ_f is derived from the map using the actual operating conditions and the coolant temperature T_cw. Further, from the relationship with the required torque τ_req (indicated torque τ_a transmitted to the crankshaft la by combustion of the air-fuel mixture at the optimum ignition timing θo) under the operating condition, the advance limit value θ_lim(−) is calculated by the following Expression (5).

θ_lim(−)=θ_mbt−{(τ_a−τ_f)/(C×τ_f)}^{0.5} (5)

In the above Expression (5), θ_mbt represents the ignition timing θ at which the indicated torque τ_a of the engine 1 is maximized, and C represents a coefficient of an equation obtained by approximating the energy distribution η_i to the power of the engine 1 with respect to the ignition timing θ by a quadratic function of the ignition timing θ. The approximate expression is expressed by the following Expression (6).

η_i(θ)=η_i_max+C×(θ−θ_mbt)² (6)

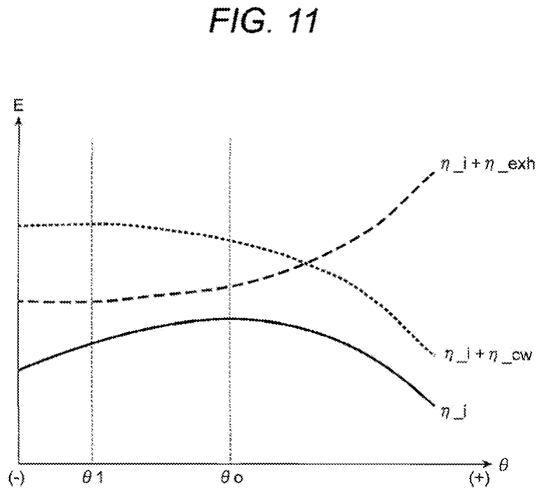

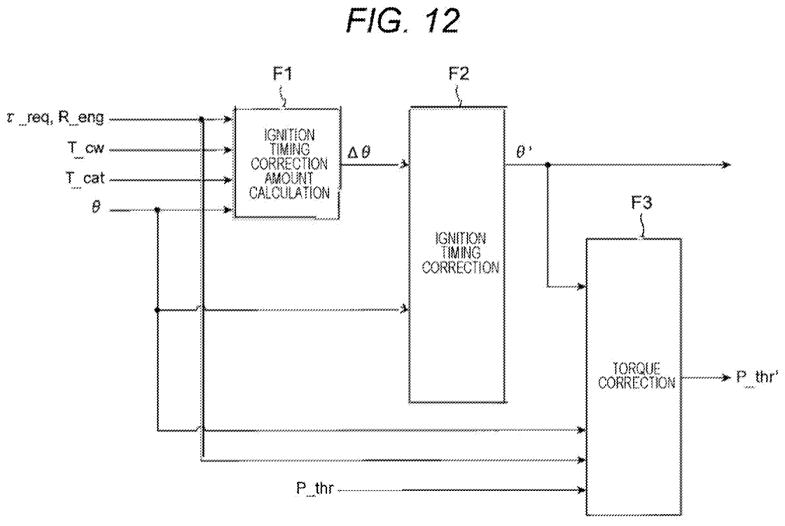

In the above Expression (6), η_i_max is a maximum value of the energy distribution η_i to the power of the engine 1. When the approximate expression is not used, it is also possible to map the energy distribution η_i to the power of the engine 1 according to the ignition timing e and derive the advance limit value θ_lim(−) from the map. As illustrated in FIG. 11, the advance limit value θ_lim(−) may be set from the viewpoint of energy utilization efficiency.

FIG. 11 is a graph for explaining energy distribution of the engine 1 as an internal combustion engine. In the graph of FIG. 11, the vertical axis represents energy E, and the horizontal axis represents the ignition timing e of the engine 1. In the graph of FIG. 11, the energy distribution η_i to the power of the engine 1 is indicated by a solid line. A power-coolant distribution η_i+η_cw, which is the sum of the energy distribution η_i to the power of the engine 1 and the energy distribution η_cw from the engine 1 to the coolant, is indicated by a dotted line. Further, a power-exhaust distribution η_i+η_exh, which is the sum of the energy distribution η_i to the power of the engine 1 and the energy distribution η_exh from the engine 1 to the exhaust gas, is indicated by a broken line.

The advance limit value θ_lim(−) in the process P9 of FIG. 10 can be set to, for example, the ignition timing el at which the power-coolant distribution ᵢᵢ i+₁₁ cw illustrated in FIG. 11 is maximized.

Next, setting of the above-described retardation limit value θ_lim(+) will be described. The retardation limit value θ_lim(+) is a limit value of the ignition timing θ in a case where the ignition timing θ is retarded. For example, when the retard of the ignition timing θ is increased in the engine 1, the retardation limit value θ_lim(+) is set on the basis of the ignition timing θ in which the combustion state becomes unstable and the fluctuation of the torque τ of the engine 1 becomes large.

More specifically, for example, the ignition timing θ at which the fluctuation of the torque τ becomes larger than a predetermined threshold is mapped according to the operating condition such as the torque τ and the rotation speed of the engine 1 and the coolant temperature T_cw. Then, the retardation limit value θ_lim(+) at which the fluctuation of the torque τ becomes equal to or less than the threshold is set on the basis of the ignition timing θ at which the fluctuation of the torque τ derived from the map using the actual operation condition and the coolant temperature T_cw becomes large.

When the map as described above is not used, for example, the ignition timing θ at which the torque τ becomes unstable may be calculated by the function F2 of correcting the ignition timing of the control device 10 on the basis of the relationship between the ignition timing θ and the fluctuation of the rotation speed of the engine 1 based on the detection result of the crank angle sensor S1. In this case, the function F2 sets the retardation limit value θ_lim(+) at which the torque τ is not destabilized on the basis of the calculated ignition timing θ at which the torque τ becomes unstable.

When the torque τ of the engine 1 is smaller than friction torque for operating the engine 1, the engine 1 cannot be operated. Therefore, the retardation limit value θ_lim(+) of the retardation control is set on the basis of the range in which the rotation of the engine 1 as the internal combustion engine can be continued. That is, when the torque τ of the engine 1 is small and the difference between the torque τ of the engine and the friction torque is smaller than a predetermined value, the retardation limit value θ_lim(+) is set on the basis of the relationship between the torque τ of the engine 1 and the friction torque.

More specifically, for example, similarly to the advance limit value θ_lim(−) described above, the retardation limit value θ_lim(+) is calculated by the following Expression (7) from the relationship with the required torque τ_req (indicated torque τ_a at the optimum ignition timing eo) under the actual operating condition.

θ_lim(+)=θ_mbt−{(τ_a−τ_f)/(C×τ_f)}^{0.5} (7)

Similarly to the advance limit value θ_lim(−) described above, when the approximate expression of Expression (6) is not used, it is also possible to map the energy distribution η_i to the power of the engine 1 according to the ignition timing e and derive the retardation limit value θ_lim(+) from the map.

Hereinafter, the operation of the control device 10 of an internal combustion engine according to the present embodiment will be described.

It is expected that regulations on fuel consumption and exhaust of vehicles such as automobiles will be further strengthened in the future. In particular, the regulations on fuel consumption have been attracting increasing attention due to problems such as recent fuel price increase, influence on global warming, and energy resource depletion. In order to cope with the regulations on automobile fuel consumption that is strengthened year by year, the market of hybrid vehicles having a high fuel consumption reduction effect is expanding.

A hybrid vehicle includes a motor and an engine as power sources, and drives both the motor and the engine or one of the motor and the engine according to traveling conditions, thereby efficient1y traveling the vehicle. The hybrid vehicle converts kinetic energy of the vehicle into electric energy using the motor as a generator at the time of deceleration, stores the electric energy in the power storage device, and drives the motor using the electric energy to drive the vehicle, thereby improving fuel consumption.

For example, the engine of the series hybrid vehicle frequent1y stops the operation as compared with a normal automobile or a parallel hybrid vehicle. More specifically, the engine of the series hybrid vehicle improves the fuel consumption by operating under a limited condition, for example, at the time of charging the power storage device or at the time of power generation when the output of the power storage device is insufficient. However, since the operation time of the engine is shortened, the energy distribution from the engine to the exhaust gas and the energy distribution from the engine to the coolant are reduced, and the catalyst temperature of the exhaust system and the coolant temperature are likely to decrease as compared with an automobile driven by the engine.

In the conventional waste heat control device described in PTL 1, a certain effect can be obtained when the waste heat recovery of the engine by the coolant is mainly performed. However, this conventional waste heat control device has a problem that the operation frequency of the engine is low, and it is not possible to cope with a situation in which both the temperature of the catalyst included in the exhaust system of the engine and the temperature of the coolant are low.

On the other hand, the control device 10 of the internal combustion engine of the present embodiment is a device that acquires the coolant temperature T_cw and the catalyst temperature T_cat of the exhaust system to control the ignition timing θ of the engine 1, which is the internal combustion engine, as described above. As described above, the control device 10 executes the coolant heating control in the process P2 illustrated in FIG. 6, and executes the catalyst heating control in the process P5 illustrated in FIG. 8. As illustrated in FIG. 6, the coolant heating control is control for increasing the energy distribution η_cw from the internal combustion engine to the coolant when the coolant temperature T_cw is equal to or lower than the first threshold T1. As illustrated in FIG. 8, the catalyst heating control is control for increasing the energy distribution from the internal combustion engine to the exhaust gas when the catalyst temperature T_cat is equal to or lower than the second threshold T2.

With such a configuration, the control device 10 of the internal combustion engine of the present embodiment can increase the catalyst temperature T_cat and the coolant temperature T_cw more efficient1y than the conventional waste heat control device. More specifically, by correcting the ignition timing θ on the basis of the catalyst temperature T_cat and the coolant temperature T_cw which are important parameters of the internal combustion engine, it is possible to operate the energy distribution η_i to the power of the engine 1, the energy distribution η_exh to the exhaust gas, and the energy distribution η_cw to the coolant illustrated in FIG. 5. As a result, it is possible to implement appropriate control according to the state of the internal combustion engine, the coolant temperature T_cw, and the catalyst temperature T_cat to efficient1y increase the coolant temperature T_cw and the catalyst temperature T_cat, and to realize an increase in heating output, a reduction in friction loss, an improvement in exhaust purification capacity, and the like in the vehicle.

The control device 10 of the internal combustion engine of the present embodiment executes advance control for advancing the ignition timing θ in the coolant heating control executed in the above-described process P2. The control device 10 executes retardation control for delaying the ignition timing θ in the catalyst heating control executed in the above-described process P5.

With such a configuration, in the coolant heating control, as illustrated in FIG. 5, the ignition timing θ is advanced to increase the energy distribution η_cw from the engine 1 to the coolant, and as illustrated in FIG. 7, the coolant temperature T_cw can be efficient1y increased. In the catalyst heating control, as illustrated in FIG. 5, the ignition timing θ is retarded to increase the energy distribution η_exh from the engine 1 to the exhaust gas, and as illustrated in FIG. 9, the catalyst temperature T_cat can be efficient1y increased.

When the setting C2 is selected in the advance control executed in the above-described process P2, the control device 10 of the internal combustion engine of the present embodiment increases the ignition timing correction amount Δθ as the advance correction amount for advancing the ignition timing θ as the coolant temperature deviation ΔT_cw, which is the difference between the first threshold T1 and the coolant temperature T_cw, increases. With such a configuration, as illustrated in FIG. 7, in the vicinity of time t0 at which the coolant temperature deviation ΔT_cw is large, the ignition timing correction amount Δθ as the advance correction amount is large, and when the coolant temperature deviation ΔT_cw decreases with the lapse of time, the ignition timing correction amount Δθ as the advance correction amount decreases. As a result, as indicated by a chain line in the graph of the torque τ in FIG. 7, the change in the torque τ can be made gent1e, and the load on the system can be reduced.

When the setting C4 is selected in the retardation control executed in the above-described process P5, the control device 10 of the internal combustion engine of the present embodiment increases the ignition timing correction amount Δθ as the retardation correction amount that delays the ignition timing θ as the catalyst temperature deviation ΔT_cat, which is the difference between the second threshold T2 and the catalyst temperature T_cat, increases. With such a configuration, as illustrated in FIG. 9, in the vicinity of time t0 at which the coolant temperature deviation ΔT_cw is large, the ignition timing correction amount Δθ as the retardation correction amount is large, and when the coolant temperature deviation ΔT_cw decreases with the lapse of time, the ignition timing correction amount Δθ as the retardation correction amount decreases. As a result, as indicated by a chain line in the graph of the torque τ in FIG. 9, the change in the torque τ can be made gent1e, and the load on the system can be reduced.

In the advance control, as illustrated in FIG. 10, when the ignition timing correction amount Δθ as the advance correction amount exceeds the advance limit value θ_lim(−), the control device 10 of the internal combustion engine of the present embodiment executes a process P10 for setting the ignition timing correction amount Δθ as the advance correction amount to the advance limit value θ_lim(−). With such a configuration, it is possible to avoid the setting of the ignition timing θ that exceeds the advance limit value θ_lim(−) that changes according to the operation state of the engine 1, the coolant temperature T_cw, and the like. As a result, it is possible to realize effective distribution of the energy of the engine 1 according to the coolant temperature T_cw and the catalyst temperature T_cat while suppressing damage to the engine 1, an unintended stop, fluctuation of the torque τ, and the like.

In the above-described retardation control, when the ignition timing correction amount Δθ as the retardation correction amount exceeds the retardation limit value θ_lim(+) as illustrated in FIG. 10, the control device 10 of the internal combustion engine of the present embodiment executes the process P13 for setting the ignition timing correction amount Δθ as the retardation correction amount to the retardation limit value θ_lim(+). With such a configuration, it is possible to avoid the setting of the ignition timing θ that exceeds the retardation limit value θ_lim(+) that changes according to the operation state of the engine 1, the coolant temperature T_cw, and the like. As a result, it is possible to realize effective distribution of the energy of the engine 1 according to the coolant temperature T_cw and the catalyst temperature T_cat while suppressing damage to the engine 1, an unintended stop, fluctuation of the torque τ, and the like.

In the control device 10 for the internal combustion engine according to the present embodiment, the advance limit value θ_lim(−) is set on the basis of either the ignition timing θ at which abnormal combustion of the engine 1, which is an internal combustion engine, occurs or the ignition timing at which the power-coolant distribution η_i+η_cw is maximized. The power-coolant distribution η_i+η_cw is the sum of the energy distribution η_i to the power of the engine 1, that is, the drive system and the energy distribution η_cw to the coolant. With such a configuration, in the coolant heating control for increasing the temperature of the coolant, the power of the engine 1 and the energy used for increasing the temperature of the coolant can be maximized, and the utilization efficiency of the energy of the entire system can be improved.

In the control device 10 for the internal combustion engine according to the present embodiment, the above-described retardation limit value θ_lim(+) is set on the basis of the ignition timing at which the combustion state of the engine 1 as the internal combustion engine becomes unstable. With such a configuration, in the catalyst heating control for increasing the temperature of the catalyst temperature T_cat, the combustion state of the engine 1 can be stabilized, the fluctuation of the torque τ can be prevented, and the torque τ can be stabilized.

In the control device 10 of the internal combustion engine of the present embodiment, the advance limit value θ_lim(−) of the advance control and the retardation limit value θ_lim(+) of the retardation control described above are set on the basis of the range in which the rotation of the engine 1 as the internal combustion engine can be continued. With such a configuration, the torque τ of the engine 1 can be prevented from becoming smaller than the friction torque, and the engine 1 can be reliably driven.

As described above, according to the present embodiment, it is possible to provide the control device 10 of the internal combustion engine capable of increasing the catalyst temperature T_cat and the coolant temperature T_cw more efficient1y than the conventional waste heat control device.

### Second Embodiment

Next, a second embodiment of the control device of the internal combustion engine according to the present disclosure will be described with reference to FIGS. 1 to 3 and FIGS. 12 to 15.

FIG. 12 is a functional block diagram of the control device 10 according to the present embodiment. The control device 10 of the internal combustion engine of the present embodiment has, for example, the function F1 of calculating the ignition timing correction amount Δθ and the function F2 of correcting the ignition timing θ, similarly to the control device 10 of the internal combustion engine of the first embodiment described above. The control device 10 of the present embodiment further has a function F3 of correcting the torque τ. In the control device 10 of the present embodiment, the same parts as those of the control device 10 of the first embodiment described above are denoted by the same reference numerals, and the description thereof will be omitted.

As illustrated in FIG. 12, the function F3 of correcting the torque τ uses, for example, the required torque τ_req and the rotational speed R_eng of the engine 1, the ignition timing 91 before correction, the ignition timing 91′ after correction, and the thrott1e opening degree P_thr as inputs. The function F3 calculates a corrected thrott1e opening degree P_thr′ for correcting the decrease in the torque τ due to the corrected ignition timing θ′ on the basis of these inputs.

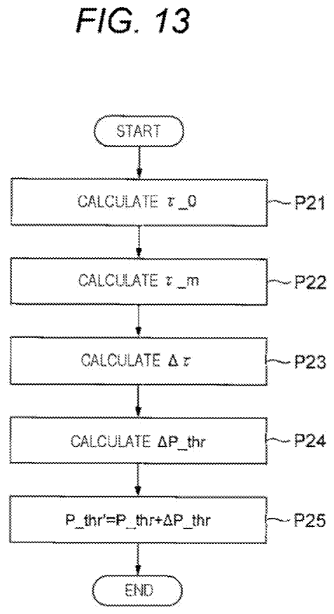

FIG. 13 is a flowchart for explaining processing by the function F3 of correcting the torque τ in FIG. 12. When the processing flow illustrated in FIG. 13 is started, the function F3 first executes a process P21 for calculating torque τ_0 of the engine 1 based on the ignition timing 91 before correction. In the process P21, the function F3 can calculate the torque τ_0 of the engine 1 based on the ignition timing θ before correction by the following Expression (8) using the energy distributions η_i, η_exh, and η_cw to the power of the engine 1, the exhaust, and the coolant as illustrated in FIG. 5, for example.

τ_0=η_i(θ0)×Mf×Hl/(2×Π×R) (8)

Here, η_i(θ0) is an energy distribution η_i to the power of the engine 1 at an ignition timing θ0. Mf is a fuel supply amount [kg] per cycle of the engine 1, Hl is a low calorific value [J/kg] of the fuel, n is a circular constant, and R is a crank radius [m]. The torque τ_0 of the engine 1 based on the ignition timing θ before correction calculated as described above is considered to be equivalent to the required torque τ_req.

Next, the function F3 of correcting the torque τ executes a process P22 for calculating torque τ_m based on the corrected ignition timing Gθ40 by the following Expression (9). Here, η_i (θm) is an energy distribution η_i to the power of the engine 1 at an ignition timing θm.

τ_m=η_i(θm)×Mf×Hl/(2×Π×R) (9)

Next, the function F3 of correcting the torque τ executes a process P23 for calculating the torque decrease amount Δτ by subtracting the torque τ_m at the corrected ignition timing θ′ calculated in the process P22 from the torque τ_0 of the engine 1 at the corrected ignition timing θ calculated in the process P21.

Next, the function F3 of correcting the torque τ executes a process P24 for calculating a correction amount ΔP_thr of the thrott1e opening degree. The correction amount ΔP_thr of the thrott1e opening degree is a correction amount of the thrott1e opening degree P_thr for compensating the decrease amount of the torque τ due to the corrected ignition timing θ′ and generating the torque τ due to the ignition timing θ before correction.

In the control device 10, for example, a map indicating the relationship between the thrott1e opening degree P_thr of the electronically controlled thrott1e 1c and an air flow rate FR_air is stored in the ROM 14. The function F3 of correcting the torque τ obtains the current air flow rate FR_air on the basis of the current thrott1e opening degree P_thr from the map. Further, the function F3 uses the flow rate FR_air of the air before correction, the corrected torque decrease amount Δτ, and the torque τ_0 before correction to obtain a corrected air flow rate FR_air′ expressed by the following Expression (10).

FR_air′=FR_air×(1+Δτ/τ_0) (10)

Then, the function F3 calculates a correction amount ΔP_thr of the thrott1e opening degree that realizes the corrected air flow rate FR_air′ on the basis of the current thrott1e opening degree P_thr. Next, the function F3 of correcting the torque τ executes a process P25 of adding the calculated correction amount ΔP_thr of the thrott1e opening degree and the current thrott1e opening degree P_thr to obtain the corrected thrott1e opening degree P_thr′ for realizing the corrected air flow rate FR_air′. Thus, the processing flow illustrated in FIG. 13 ends. The flow rate of air taken into the engine 1 may be increased by a device other than the electronically controlled thrott1e 1c.

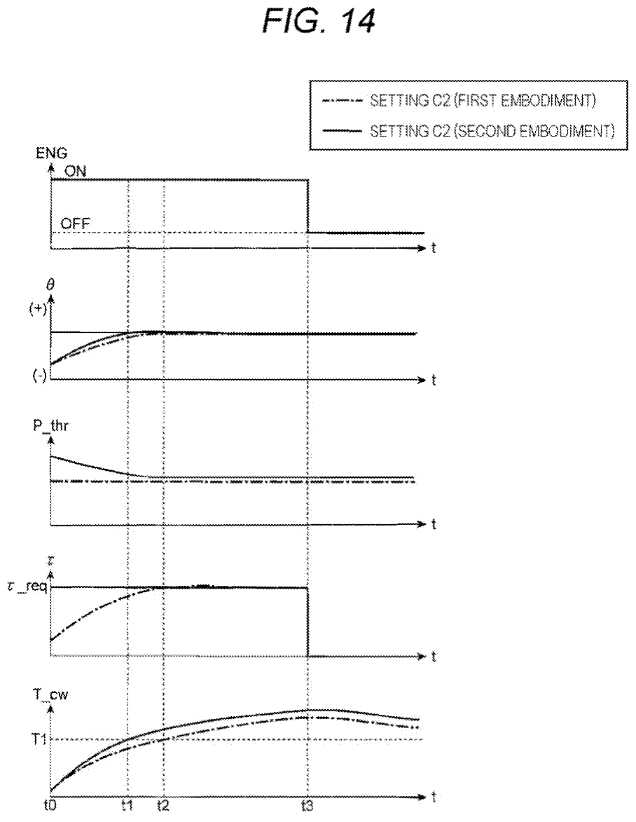

FIG. 14 is a graph illustrating a result of the processing of FIG. 13. FIG. 14 illustrates a graph including a vertical axis similar to the graph illustrated in FIG. 7 described in the first embodiment except that a graph in which the vertical axis is the thrott1e opening degree P_thr is added.

In each of the graphs excluding the graph indicating on and off of the engine 1 in FIG. 14, the states of the engine 1 of the setting C2 of the advance control by the control device 10 of the first embodiment and the setting C2 of the advance control by the control device 10 of the present embodiment are indicated by a chain line and a solid line. The setting C2 is control for increasing the advance correction amount for advancing the ignition timing θ as the difference between the coolant temperature T_cw and the first threshold T1 increases in the advance control.

As illustrated in FIG. 14, when the required torque τ_req is input at time t0, the engine 1 is started and turned on. Here, in order to facilitate understanding of the operation of the engine 1, a case where the required torque τ_req is constant will be described. In the control device 10 of the first embodiment indicated by a chain line, when the engine 1 is started at time t0, for example, the ignition timing θ before correction is set, and the thrott1e opening degree P_thr is set so as to satisfy the required torque τ_req.

As a result, in the setting C2 of the advance control by the control device 10 of the first embodiment, energy is supplied as heat from the engine 1 to the coolant in the on state in which the engine 1 is operating. As a result, as indicated by a chain line in the graph of the coolant temperature T_cw in FIG. 14, the coolant temperature T_cw gradually rises.

On the other hand, in the setting C2 of the advance control by the control device 10 of the present embodiment, each process illustrated in FIG. 13 is executed, and the thrott1e opening degree P_thr is corrected to compensate for the torque decrease amount Δτ at time t0. That is, the control device 10 of the present embodiment increases the thrott1e opening degree P_thr of the engine 1 more than the advance control by the control device 10 of the first embodiment so as to compensate for the torque τ of the engine 1 as the internal combustion engine reduced by the advance control.

As a result, as illustrated in the graph of the torque τ, in the setting C2 of the advance control by the control device 10 of the present embodiment, a decrease in the torque τ with respect to the required torque τ_req occurring in the setting C2 of the advance control by the control device 10 of the first embodiment is prevented. Therefore, in the setting C2 of the advance control by the control device 10 of the present embodiment, torque equivalent to the required torque τ_req can be generated.

In the setting C2 of the advance control by the control device 10 of the present embodiment, the thrott1e opening degree P_thr is increased more than the setting C2 of the advance control by the control device 10 of the first embodiment from time t0 to time t1 when the coolant temperature T_cw is equal to or less than the first threshold T1. As a result, in the setting C2 of the advance control by the control device 10 of the present embodiment, the flow rate of air taken into the engine 1 is increased as compared with the setting C2 of the advance control by the control device 10 of the first embodiment, and the energy distribution η_cw from the engine 1 to the coolant can be increased.

Therefore, the control device 10 of the present embodiment can increase the coolant temperature T_cw in a shorter time and can make the final coolant temperature T_cw higher as compared with the control device 10 of the first embodiment. It also allows the engine 1 to generate the required torque τ_req during the execution of the coolant heating control. Therefore, the energy distribution η_cw to the coolant can be increased while the required torque τ_req is satisfied, and both the performance of the system and the performance improvement of the system using the energy of the coolant, for example, heating, can be achieved.

Examples of the condition that the required torque τ_req needs to be satisfied include an idle operation condition in which the torque τ equivalent to the friction torque needs to be continuously generated, and a high-speed/high-output operation condition in which the output of the power storage device 4 is insufficient and the motor 5 is driven by the output of the generator 2.

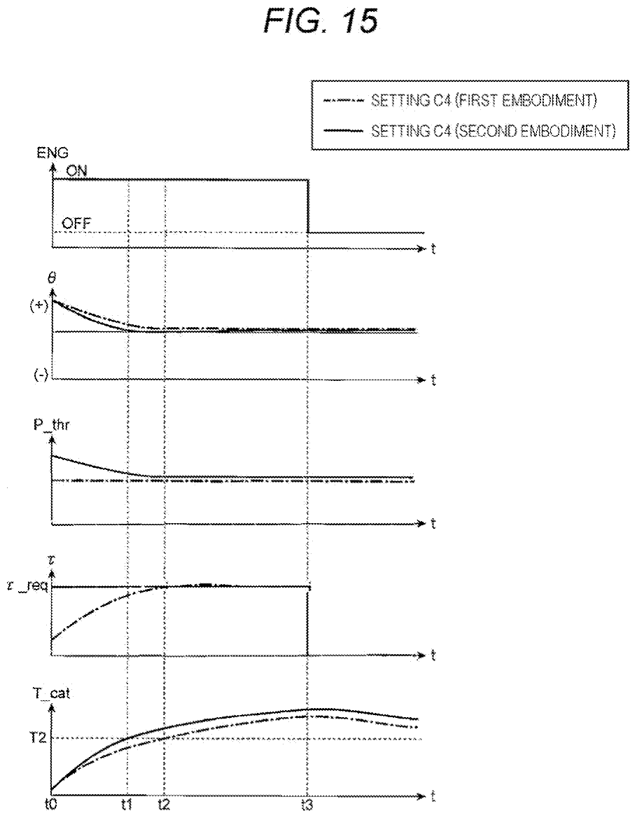

FIG. 15 is a graph illustrating a result of the processing of FIG. 13. FIG. 15 illustrates a graph including a vertical axis similar to the graph illustrated in FIG. 9 described in the first embodiment except that a graph in which the vertical axis is the thrott1e opening degree P_thr is added.

In each of the graphs excluding the graph indicating on and off of the engine 1 in FIG. 15, the states of the engine 1 of the setting C4 of the retardation control by the control device 10 of the first embodiment and the setting C4 of the retardation control by the control device 10 of the present embodiment are indicated by a chain line and a solid line. The setting C4 is control for increasing the retardation correction amount for delaying the ignition timing θ as the difference between the catalyst temperature T_cat and the second threshold T2 increases in the retardation control.

As illustrated in FIG. 15, when the required torque τ_req is input at time t0, the engine 1 is started and turned on. Here, in order to facilitate understanding of the operation of the engine 1, a case where the required torque τ_req is constant will be described. In the control device 10 of the first embodiment indicated by a chain line, when the engine 1 is started at time t0, for example, the ignition timing θ before correction is set, and the thrott1e opening degree P_thr is set so as to satisfy the required torque τ_req.

As a result, in the setting C4 of the retardation control by the control device 10 of the first embodiment, energy is supplied as heat from the engine 1 to the exhaust gas in the on state in which the engine 1 is operating.

As a result, the catalyst temperature T_cat gradually rises as indicated by a chain line in the graph of the catalyst temperature T_cat in FIG. 15.

On the other hand, in the setting C4 of the retardation control by the control device 10 of the present embodiment, each process illustrated in FIG. 13 is executed, and the thrott1e opening degree P_thr is corrected to compensate for the torque decrease amount Δθ at time t0. That is, the control device 10 of the present embodiment increases the thrott1e opening degree P_thr of the engine 1 more than the retardation control by the control device 10 of the first embodiment so as to compensate for the torque τ of the engine 1 as the internal combustion engine reduced by the retardation control.

As a result, as illustrated in the graph of the torque τ, in the setting C4 of the retardation control by the control device 10 of the present embodiment, a decrease in the torque τ with respect to the required torque τ_req occurring in the setting C4 of the retardation control by the control device 10 of the first embodiment is prevented. Therefore, in the setting C4 of the retardation control by the control device 10 of the present embodiment, torque equivalent to the required torque τ_req can be generated.

That is, the control device 10 of the present embodiment increases the thrott1e opening degree P_thr of the internal combustion engine so as to compensate for the torque τ of the internal combustion engine reduced by the advance control or the retardation control. With this configuration, a decrease in the torque τ of the engine 1 is prevented by the advance control or the retardation control by the control device 10, and torque equivalent to the required torque τ_req can be generated.

In the setting C4 of the retardation control by the control device 10 of the present embodiment, the thrott1e opening degree P_thr is increased more than the setting C4 of the retardation control by the control device 10 of the first embodiment from time t0 to time t1 when the catalyst temperature T_cat is equal to or lower than the second threshold T2. As a result, in the setting C4 of the retardation control by the control device 10 of the present embodiment, the flow rate of air taken into the engine 1 is increased as compared with the setting C4 of the retardation control by the control device 10 of the first embodiment, and the energy distribution η_exh from the engine 1 to the exhaust gas can be increased.

Therefore, the control device 10 of the present embodiment can increase the catalyst temperature T_cat in a shorter time and make the final catalyst temperature T_cat higher as compared with the control device 10 of the first embodiment. It also allows the engine 1 to generate the required torque τ_req during the execution of the catalyst heating control. Therefore, it is possible to increase the energy distribution η_exh to the exhaust gas while satisfying the required torque τ_req, and to achieve both the performance of the system and the improvement of the exhaust purification performance by the catalyst of the exhaust system such as the three-way catalyst 1h.

Examples of the condition that the required torque τ_req needs to be satisfied include an idle operation condition in which the torque τ equivalent to the friction torque needs to be continuously generated, and a high-speed/high-output operation condition in which the output of the power storage device 4 is insufficient and the motor 5 is driven by the output of the generator 2.

### Third Embodiment

Next, a third embodiment of the control device of the internal combustion engine according to the present disclosure will be described with reference to FIGS. 1 to 3 and FIGS. 16 to 19.

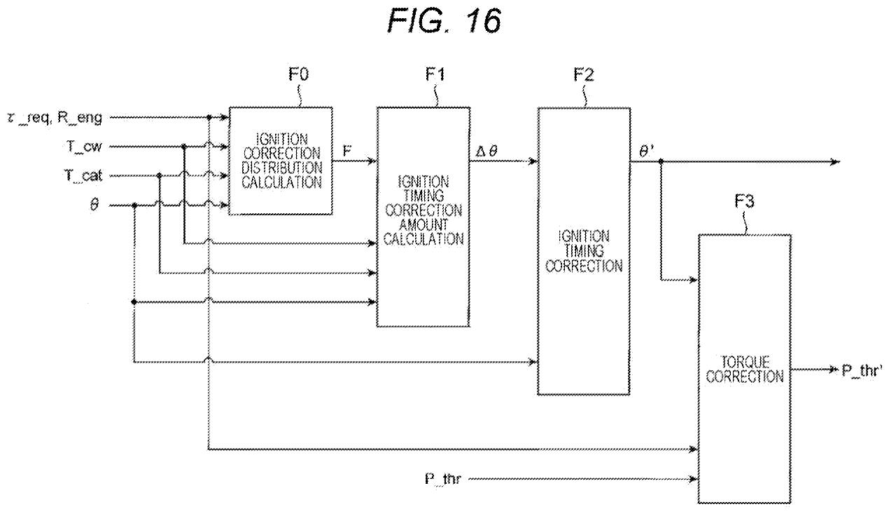

FIG. 16 is a functional block diagram illustrating the third embodiment of the control device of the internal combustion engine according to the present disclosure. The control device 10 of the present embodiment is different from the control device 10 according to the above-described second embodiment illustrated in FIG. 12 in that it has a function FO of calculating the distribution of the ignition correction amount. Note that, in the control device 10 of the present embodiment, the same components as those of the control device 10 of the above-described second embodiment are denoted by the same reference numerals, and description thereof is omitted.

As illustrated in FIG. 16, the function F0 of calculating the distribution of the ignition correction amount uses, for example, the required torque τ_req and the rotational speed R_eng of the engine 1, the coolant temperature T_cw, the catalyst temperature T_cat, and the ignition timing θ as inputs. The function F0 determines distribution of the ignition correction amount on the basis of these inputs, and outputs a flag F indicating a control mode. In the control device 10 of the present embodiment, the function F1 of calculating the ignition timing correction amount Δθ uses the flag F output from the function F0, the coolant temperature T_cw, the coolant temperature T_cw, and the ignition timing θ as inputs.

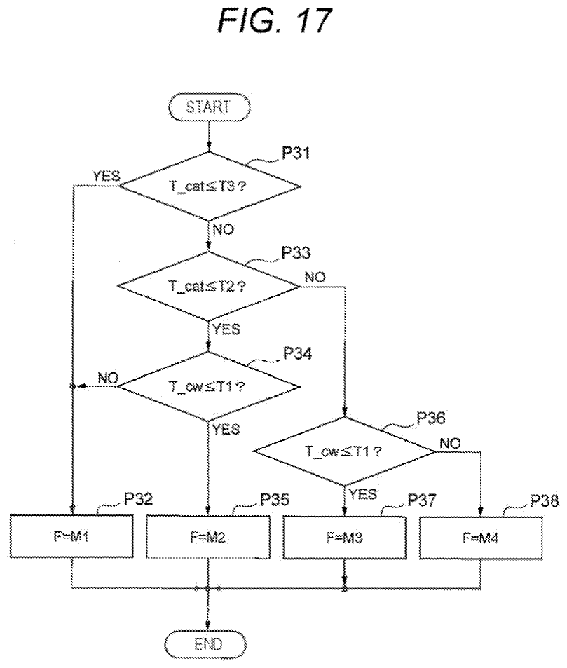

FIG. 17 is a flowchart illustrating processing by the function F0 of calculating the distribution of the ignition correction of FIG. 16. When the processing flow illustrated in FIG. 17 is started, the function F0 first executes a process P31 for determining whether the catalyst temperature T_cat is equal to or lower than a third threshold T3 that is a predetermined temperature threshold. The third threshold T3 is set to, for example, a value lower than the second threshold T2 used in a process P33 described later. In the process P31, when determining that the catalyst temperature T_cat is equal to or lower than the third threshold T3 (YES), the function F0 executes the next process P32.

In the process P32, the function F0 of calculating the distribution of the ignition correction sets the flag F to “mode M1” and ends the process illustrated in FIG. 17. The mode M1 is a mode in which heating of the three-way catalyst 1h which is the catalyst of the exhaust system of the engine 1 is prioritized.

On the other hand, in the process P31, when the function F0 of calculating the allocation of the ignition correction determines that the catalyst temperature T_cat is higher than the third threshold T3 (NO), the function F0 executes the next process P33. In the process P33, the function F0 determines whether the catalyst temperature T_cat is equal to or lower than the second threshold T2 which is a predetermined temperature threshold. As described above, the second threshold T2 is set to a temperature higher than the third threshold T3. In this process P33, when determining that the catalyst temperature T_cat is equal to or lower than the second threshold T2 (YES), the function F0 executes the next process P34.

In the process P34, the function F0 of calculating the distribution of the ignition correction determines whether the coolant temperature T_cw is equal to or less than the first threshold T1. In the process P34, when determining that the coolant temperature T_cw is higher than the first threshold T1 (NO), the function F0 executes the above-described process P32, sets the flag F to the mode M1 in which heating of the three-way catalyst 1h is prioritized, and ends the processing flow illustrated in FIG. 17. On the other hand, in the process P34, when determining that the coolant temperature T_cw is equal to or lower than the first threshold T1 (YES), the function F0 executes the next process P35.

In the process P35, the function F0 of calculating the distribution of the ignition correction sets the flag F to “mode M2” and ends the process illustrated in FIG. 17. The mode M2 is a mode in which heating of the three-way catalyst 1h which is a catalyst of the exhaust system of the engine 1 and heating of the coolant are simultaneously executed.

On the other hand, in the process P33, when the function F0 of calculating the distribution of the ignition correction determines that the catalyst temperature T_cat is higher than the second threshold T2 (NO), the function F0 executes the next process P36. In the process P36, the function F0 determines whether the coolant temperature T_cw is equal to or lower than the first threshold T1 as in the process P34 described above. In the process P36, when the function F0 determines that the coolant temperature T_cw is equal to or lower than the first threshold T1 (YES), the function F0 executes the next process P37.

In the process P37, the function F0 of calculating the distribution of the ignition correction sets the flag F to “mode M3” and ends the process illustrated in FIG. 17. The mode M3 is a mode in which heating of the coolant is prioritized. On the other hand, in the process P36, when determining that the coolant temperature T_cw is higher than the first threshold T1 (NO), the function F0 executes the next process P38.

In the process P38, the function F0 of calculating the distribution of the ignition correction sets the flag F to “mode M4” and ends the process illustrated in FIG. 17. The mode M4 is a mode for maintaining both the catalyst temperature T_cat and the coolant temperature T_cw. Next, a flow of processing by the function F1 of calculating the ignition timing correction amount Δθ of the control device 10 of the present embodiment illustrated in FIG. 16 will be described.

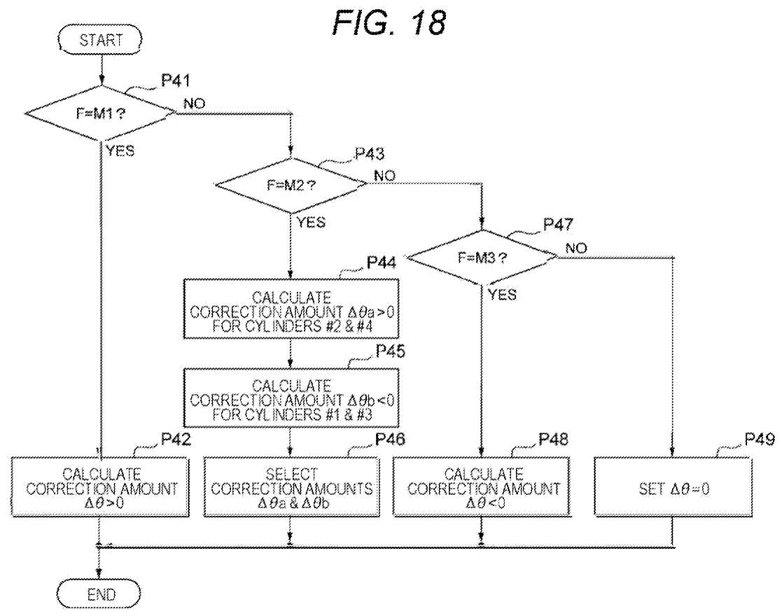

FIG. 18 is a flowchart illustrating an example of processing by the function F1 of calculating the ignition timing correction amount Δθ of FIG. 16. As described above, the function F1 uses the flag F output from the function F0 of calculating the distribution of the ignition correction, the coolant temperature T_cw, the catalyst temperature T_cat, and the ignition timing θ as inputs.

When the processing flow illustrated in FIG. 18 is started, the function F1 first executes a process P41 for determining whether the flag F is the mode M1 in which heating of the catalyst is prioritized.

In the process P41, when determining that the flag F is the mode M1 in which heating of the catalyst is prioritized (YES), the function F1 of calculating the ignition timing correction amount Δθ executes the next process P42.

In the process P42, the function F1 executes catalyst heating control for increasing the energy distribution η_exh from the engine 1 to the exhaust gas, similarly to the process P5 by the function F1 of the first embodiment described above.

More specifically, in the process P42, the function F1 executes the retardation control for setting the ignition timing correction amount Δθ to a positive value, and ends the processing flow illustrated in FIG. 18.

On the other hand, in the process P41, when the function F1 of calculating the ignition timing correction amount Δθ determines that the flag F is not the mode M1 that prioritizes the heating of the catalyst (NO), the next process P43 is executed. In the process P43, the function F1 determines whether the flag F is the mode M2 in which heating of the catalyst and heating of the coolant are simultaneously performed. In the process P43, when it is determined that the flag F indicates the mode M2 in which heating of the catalyst and heating of the coolant are simultaneously performed (YES), the function F1 executes the next process P44 to the process P46.

In the processes P44 to P46, the function F1 of calculating the ignition timing correction amount Δθ selects the ignition timing correction amounts Δθa and Δθb so as to execute the retardation control on some cylinders 1d and the advance control on the other cylinders 1d among the plurality of cylinders 1d constituting the engine 1 as the internal combustion engine.

More specifically, in the process P44, the function F1 of calculating the ignition timing correction amount Δθ calculates, for example, a positive ignition timing correction amount Δθa as a retardation correction amount for the cylinders 1d of #2 and #4 among the plurality of cylinders 1d constituting the engine 1 illustrated in FIG. 2. In the process P45, the function F1 calculates the negative ignition timing correction amount Δθb as the advance correction amount for the cylinders 1d of #1 and #3 among the plurality of cylinders 1d constituting the engine 1 illustrated in FIG. 2, for example.

The cylinder 1d that performs the advance control or the retardation control is not limited to the above combination.

The method of calculating the ignition timing correction amount Δθa which is the retardation correction amount and the ignition timing correction amount Δθb which is the advance correction amount is similar to those in the first and second embodiments.

In the process P46, the function F1 of calculating the ignition timing correction amount Δθ selects the ignition timing correction amounts Δθa and Δθb on the basis of, for example, a torque decrease amount Δτa by the retardation control and a torque decrease amount Δτb by the advance control. The torque decrease amount Δτa by the retardation control and the torque decrease amount Δτb by the advance control can be calculated on the basis of, for example, the following Expressions (11) and (12).

Δτa={η_i(θ)−η_i(θ+Δθa)}×Mf×Hl/(2×Π×R) (11)

Δτb={η_i(θ)−η_i(θ+Δθb)}×Mf×Hl/(2×Π×R) (12)

Here, Δτa is the torque decrease amount by the retardation control, Δτb is the torque decrease amount by the advance control, and η_i(θ) is the energy distribution η_i to the power of the engine 1 at the ignition timing θ.

Mf is a fuel supply amount [kg] per cycle of the engine 1, Hl is a low calorific value [J/kg] of the fuel, n is a circular constant, and R is a crank radius [m].

In the process P46, the function F1 of calculating the ignition timing correction amount Δθ selects the ignition timing correction amount Δθb calculated in the process P45 as the ignition timing correction amount Δθ of the advance control, for example, when the torque decrease amount Δτa of the retardation control is larger than the torque decrease amount Δτb of the advance control. In this case, the function F1 calculates, as the ignition timing correction amount Δθ of the retardation control, the ignition timing correction amount Δθa by which the torque decrease amount Δτa of the retardation control is equivalent to the torque decrease amount Δτb of the advance control, for example, by the following Expression (13).

Δθa=θ_mbt−θ+{2×ΠR×Δρa/(C×Mf×Hl)+(θ−θ_mbt)²}^{0.5} (13)

In the above Expression (13), θ_mbt represents the ignition timing θ at which the indicated torque τ_a of the engine 1 is maximum, n represents the circular constant, R represents the crank radius [m], Mf represents the fuel supply amount [kg] per cycle of the engine 1, and Hl represents the low calorific value [J/kg] of the fuel. C is a coefficient of an equation in which the energy distribution η_i to the power of the engine 1 with respect to the ignition timing θ is approximated by a quadratic function of the ignition timing θ. The approximate expression is expressed by the above Expression (6). When the approximate expression is not used, the energy distribution η_i to the power of the engine 1 according to the ignition timing θ is mapped, and the ignition timing correction amount Δθa in which the torque decrease amount Δτa of the retardation control is equivalent to the torque decrease amount Δτb of the advance control can be derived from the map.

In the process P46, the function F1 of calculating the ignition timing correction amount Δθ selects the ignition timing correction amount Δθa calculated in the process P44 as the ignition timing correction amount Δθ of the retardation control, for example, when the torque decrease amount Δτb of the advance control is larger than the torque decrease amount Δτa of the retardation control. In this case, the function F1 calculates, as the ignition timing correction amount Δθ of the advance control, the ignition timing correction amount Δθb by which the torque decrease amount Δτb of the advance control is equivalent to the torque decrease amount Δτa of the retardation control, for example, by the following Expression (14).

Δθb=θ_mbt−θ+{2×Π×R×Δτb/(C×Mf×Hl)+(θ−θ_mbt)²}^{0.5} (14)

In the above Expression (14), θ_mbt, Π, R, Mf, H1, and the like are the same as those in the above Expression (13). When the approximate expression is not used, the energy distribution η_i to the power of the engine 1 according to the ignition timing θ is mapped, and the ignition timing correction amount Δθb in which the torque decrease amount Δτb of the advance control is equivalent to the torque decrease amount Δτa of the retardation control can be derived from the map.

As described above, in the function F1 of calculating the ignition timing correction amount Δθ, the ignition timing correction amounts Δθa and Δθb are selected so that the retardation control is performed in some cylinders 1d and the advance control is performed in the other cylinders 1d among the plurality of cylinders 1d of the engine 1 in the processes P44 to P46. Thereafter, the function F1 ends the processing flow illustrated in FIG. 18.

On the other hand, in the process P43 described above, when the function F1 of calculating the ignition timing correction amount Δθ determines that the flag F is not the mode M2 for simultaneously heating the catalyst and the coolant (NO), the next process P47 is executed. In the process P47, the function F1 determines whether the flag F is in the mode M3 in which the heating of the coolant is prioritized.

In the process P47, when the function F1 of calculating the ignition timing correction amount Δθ determines that the flag F is the mode M3 that prioritizes the heating of the coolant (YES), the next process P48 is executed. In the process P48, the function F1 executes the coolant heating control for increasing the energy distribution η_cw from the engine 1 to the coolant similarly to the process P2 by the function F1 of the first embodiment described above. More specifically, in the process P48, the function F1 executes advance control for setting the ignition timing correction amount Δθ to a negative value, and ends the processing flow illustrated in FIG. 18.

On the other hand, in the process P47, when the function F1 of calculating the ignition timing correction amount Δθ determines that the flag F is not the mode M3 that prioritizes the heating of the coolant (NO), the next process P49 is executed. In the process P49, the function F1 sets the ignition timing correction amount Δθ to zero similarly to the process P3 by the function F1 of the first embodiment described above, and ends the processing flow illustrated in FIG. 18.

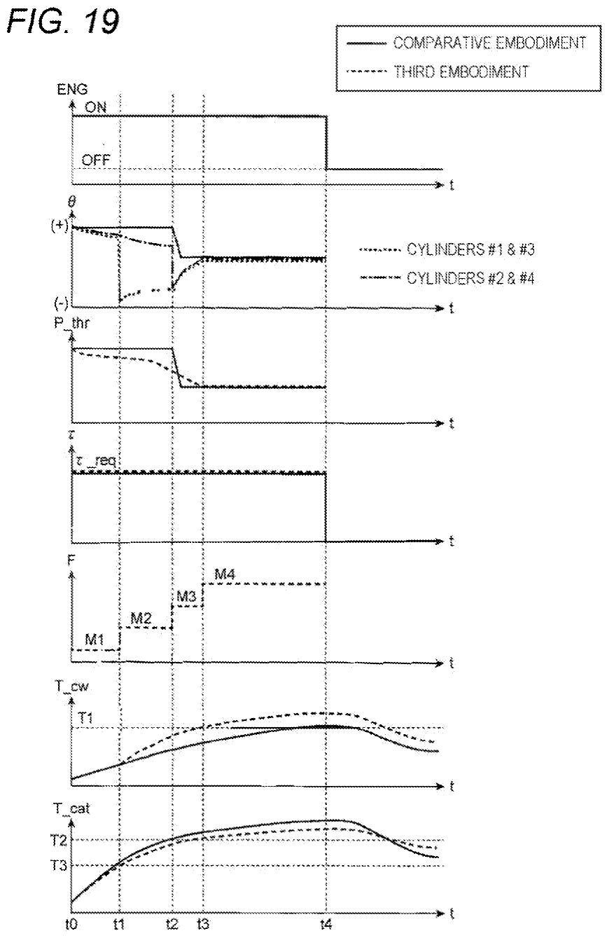

FIG. 19 is a graph illustrating a result of the processing illustrated in FIGS. 17 and 18. FIG. 19 illustrates a graph including a vertical axis similar to the graphs illustrated in FIGS. 14 and 15 described in the second embodiment described above except that the graph in which the vertical axis is the flag F is added.

In the graphs excluding the graph indicating on and off of the engine 1 and the graph indicating the flag F in FIG. 19, the states of the engine 1 according to the comparative embodiment using the conventional control device and the control of the control device 10 according to the present embodiment are indicated by a solid line and a broken line, respectively. In the graph of the ignition timing θ illustrated in FIG. 19, the ignition timings θ of the cylinders 1d of #1 and #3 among the plurality of cylinders 1d of the engine 1 controlled by the control device 10 of the present embodiment are indicated by dotted lines, and the ignition timings θ of the cylinders 1d of #2 and #4 are indicated by chain lines.

As illustrated in FIG. 19, when the required torque τ_req is input at time t0, the engine 1 is started and turned on. Here, in order to facilitate understanding of the operation of the engine 1, a case where the required torque τ_req is constant will be described.

The control device of the comparative embodiment performs retardation control to delay the ignition timing θ from the optimum ignition timing θo at the time of starting the engine 1, and the thrott1e opening degree P_thr is set so as to satisfy the required torque τ_req. By the control of the control device of this comparative embodiment, energy is supplied to the three-way catalyst 1h which is a catalyst of the exhaust system during the operation of the engine 1, and the catalyst temperature T_cat increases. When the catalyst temperature T_cat exceeds a predetermined threshold at time t2, the control device of the comparative embodiment stops the retardation control and returns the ignition timing θ to the optimum ignition timing θo.

On the other hand, in the engine 1 controlled by the control device 10 of the present embodiment, the catalyst temperature T_cat is equal to or lower than the third threshold T3 from time t0 to time t1. Therefore, the control device 10 executes the process P32 illustrated in FIG. 17 by the function FO of distributing the ignition correction amount, and sets the flag F to the mode M1 in which heating of the three-way catalyst 1h is prioritized. As a result, the control device 10 of the present embodiment executes the process P42 illustrated in FIG. 18 by the function F1 of calculating the ignition timing correction amount Δθ, and calculates the positive ignition timing correction amount Δθ as the retardation control amount.

As a result, as illustrated in FIG. 19, the retardation control for delaying the ignition timing θ is performed in all the cylinders 1d of the engine 1 from time t0 to time t1. As a result, the temperature of the catalyst temperature T_cat rapidly increases. As the catalyst temperature deviation ΔT_cat, which is the difference between the catalyst temperature T_cat and the third threshold T3, decreases, the ignition timing correction amount Δθ as the retardation correction amount decreases, and the ignition timing θ gradually advances.

In the engine 1 controlled by the control device 10 of the present embodiment, as indicated by a broken line in FIG. 19, the catalyst temperature T_cat exceeds the third threshold T3 and is equal to or less than the second threshold T2, and the coolant temperature T_cw is equal to or less than the first threshold T1 from time t1 to time t2. Therefore, the function F0 of distributing the ignition correction amount of the control device 10 executes the process P35 illustrated in FIG. 17 from time t1 to time t2, and sets the flag F to the mode M2 in which heating of the three-way catalyst 1h of the engine 1 and heating of the coolant are simultaneously performed.

As a result, the control device 10 of the present embodiment executes the process P44 to the process P46 illustrated in FIG. 18 by the function F1 of calculating the ignition timing correction amount Δθ. As a result, the function F1 selects the ignition timing correction amounts Δθa and Δθb so as to execute the retardation control on some cylinders 1d among the plurality of cylinders 1d constituting the engine 1 and execute the advance control on the other cylinders 1d as described above from time t1 to time t2.

More specifically, the control device 10 of the present embodiment executes the advance control in the cylinders 1d of #1 and #3 of the engine 1 and executes the retardation control in the cylinders 1d of #2 and #4 of the engine 1, for example, during a period from time t1 to time t2. The advance control may be executed in the cylinders 1d of #1 and #4 of the engine 1, and the retardation control may be executed in the cylinders ld of #2 and #3 of the engine 1. As a result, between time t1 and time t2, the energy distribution η_cw from the engine 1 to the coolant is increased as compared with the engine 1 controlled by the control device of the comparative embodiment, and the coolant temperature T_cw can be increased earlier.

In the engine 1 controlled by the control device 10 of the present embodiment, the catalyst temperature T_cat exceeds the third threshold T3 and the second threshold T2 and the coolant temperature T_cw is equal to or lower than the first threshold T1 between time t2 and time t3 as indicated by a broken line in FIG. 19. Therefore, the function F0 of distributing the ignition correction amount of the control device 10 executes the process P37 illustrated in FIG. 17 from time t2 to time t3, and sets the flag F to the mode M3 in which heating of the coolant is prioritized.

As a result, the control device 10 of the present embodiment executes the process P48 illustrated in FIG. 18 by the function F1 of calculating the ignition timing correction amount Δθ. As a result, the function F1 executes the advance control on all the cylinders 1d of the engine 1 between time t2 and time t3 as illustrated in the graph of the ignition timing θ in FIG. 19. As a result, between time t2 and time t3, the energy distribution η_cw from the engine 1 to the coolant is increased as compared with the engine 1 controlled by the control device of the comparative embodiment, and the coolant temperature T_cw can be increased earlier.

Thereafter, in the engine 1 controlled by the control device 10 of the present embodiment, the coolant temperature T_cw exceeds the first threshold T1 at time t3 as indicated by a broken line in FIG. 19. Therefore, the function F0 of distributing the ignition correction amount of the control device 10 executes the process P38 illustrated in FIG. 17 after time t3, and sets the flag F to a mode M4 in which the coolant temperature T_cw and the catalyst temperature T_cat are maintained.

As a result, the control device 10 of the present embodiment executes the process P49 illustrated in FIG. 18 by the function F1 of calculating the ignition timing correction amount Δθ. As a result, the function F1 sets the ignition timing correction amount Δθ to zero after time 3. As a result, as illustrated in the graph of the ignition timing θ in FIG. 19, the ignition timings θ of all the cylinders 1d of the engine 1 become the optimum ignition timing θo.

Hereinafter, the operation of the control device 10 of the present embodiment will be described.

As described above, when the catalyst temperature T_cat is equal to or lower than the third threshold T3 lower than the second threshold T2, the control device 10 of the present embodiment increases the energy distribution η_exh to the exhaust gas to be larger than the energy distribution η_cw to the coolant in the catalyst heating control described above. With this configuration, when the temperature of the three-way catalyst 1h is lower than the predetermined third threshold T3, the temperature of the three-way catalyst 1h can be rapidly increased by giving priority to the heating of the three-way catalyst 1h, and the purification performance of exhaust can be improved.

When the catalyst temperature T_cat is higher than the second threshold T2 and the coolant temperature T_cw is equal to or lower than the first threshold T1, the control device 10 of the present embodiment increases the energy distribution η_cw to the coolant to be larger than the energy distribution η_exh to the exhaust gas in the coolant heating control. With this configuration, the temperature of the coolant can be rapidly increased, the efficiency of the engine 1 can be improved, and the heating can be rapidly used.

When the catalyst temperature T_cat is equal to or lower than the second threshold T2 and the coolant temperature T_cw is equal to or lower than the first threshold T1, the control device 10 of the present embodiment executes the retardation control on some cylinders 1d among the plurality of cylinders ld constituting the internal combustion engine and executes the advance control on the other cylinders 1d. With this configuration, the coolant temperature T_cw and the catalyst temperature T_cat can be efficient1y increased.

The control device 10 of the present embodiment may alternately execute the retardation control and the advance control in all the cylinders 1d when the catalyst temperature T_cat is equal to or lower than the second threshold T2 and the coolant temperature T_cw is equal to or lower than the first threshold T1. More specifically, the retardation control and the advance control may be switched every predetermined number of cycles of the engine 1. With this configuration, the coolant temperature T_cw and the catalyst temperature T_cat can be efficient1y increased. Since the ignition timing θ is the same among the plurality of cylinders 1d, control is facilitated as compared with a case where the ignition timing θ is set separately for some cylinders 1d and the other cylinders 1d.

The control device 10 of the present embodiment determines the retardation correction amount of the retardation control and the advance correction amount of the advance control so that the torques τ of all the cylinders 1d become equal. With this configuration, the operation of the engine 1 can be stabilized.

As described above, according to the control device 10 of the present embodiment, the ignition timing correction amount Δθ is set on the basis of the state of the catalyst temperature T_cat and the coolant temperature T_cw, and the advance control and the retardation control of the ignition timing θ are switched, so that the catalyst temperature T_cat can be quickly raised to the target temperature. By switching the distribution of the energy of the engine 1 in this manner, it is possible to achieve both the improvement of the exhaust performance and the improvement of the heating performance due to the increase in the coolant temperature. In each of the above-described embodiments, an example has been described in which the ignition timing θ is set so as to have a correlation with the difference between the catalyst temperature T_cat and the coolant temperature T_cw and the respective thresholds. However, the ignition timing θ may be set to the advance limit value θ_lim(−) or the retardation limit value θ_lim(+).

As described above, the embodiment of the control device of an internal combustion engine according to the present disclosure has been described in detail with reference to the drawings. However, the specific configuration is not limited to this embodiment, and there are design changes and the like without departing from the gist of the disclosure, which are also included in the disclosure.

### REFERENCE SIGNS LIST

1 engine (internal combustion engine)
1d cylinder
10 control device
P2 process (coolant heating control, advance control)
P5 process (catalyst heating control, retardation control)
P_thr thrott1e opening degree
T1 first threshold
T2 second threshold
T3 third threshold
T_cat catalyst temperature
T_cw coolant temperature
θ ignition timing
θ_lim(+) retardation limit value
θ_lim(−) advance limit value
η_cw energy distribution to coolant
η_exh energy distribution to exhaust gas
τ torque

1. A control device that acquires a coolant temperature and a catalyst temperature of an exhaust system and controls an ignition timing of an internal combustion engine,
wherein the control device executes:
coolant heating control for increasing an energy distribution from the internal combustion engine to a coolant when the coolant temperature is equal to or lower than a first threshold; and
catalyst heating control for increasing an energy distribution from the internal combustion engine to the exhaust gas when the catalyst temperature is equal to or lower than a second threshold.

2. The control device of the internal combustion engine according to claim 1, wherein
advance control for advancing the ignition timing is executed in the coolant heating control, and
retardation control for delaying the ignition timing is executed in the catalyst heating control.

3. The control device of the internal combustion engine according to claim 2, wherein in the advance control, an advance correction amount for advancing the ignition timing is increased as a difference between the first threshold and the coolant temperature increases.

4. The control device of the internal combustion engine according to claim 2, wherein in the retardation control, a retardation correction amount for delaying the ignition timing is increased as a difference between the second threshold and the catalyst temperature increases.

5. The control device of the internal combustion engine according to claim 1, wherein when the catalyst temperature is equal to or lower than a third threshold lower than the second threshold, an energy distribution to the exhaust gas is increased more than an energy distribution to the coolant in the catalyst heating control.

6. The control device of the internal combustion engine according to claim 1, wherein when the catalyst temperature is higher than the second threshold and the coolant temperature is equal to or lower than the first threshold, an energy distribution to the coolant is increased more than an energy distribution to the exhaust gas in the coolant heating control.

7. The control device of the internal combustion engine according to claim 2, wherein when the catalyst temperature is equal to or lower than the second threshold and the coolant temperature is equal to or lower than the first threshold, the retardation control is executed on some of a plurality of cylinders constituting the internal combustion engine, and the advance control is executed on the other cylinders.

8. The control device of the internal combustion engine according to claim 2, wherein when the catalyst temperature is equal to or lower than the second threshold and the coolant temperature is equal to or lower than the first threshold, the retardation control and the advance control are alternately executed.

9. The control device of the internal combustion engine according to claim 7, wherein a retardation correction amount of the retardation control and an advance correction amount of the advance control are determined such that pieces of torque of all the cylinders are equivalent.

10. The control device of the internal combustion engine according to claim 3, wherein in the advance control, when the advance correction amount exceeds an advance limit value, the advance correction amount is set to the advance limit value.

11. The control device of the internal combustion engine according to claim 4, wherein in the retardation control, when the retardation correction amount exceeds a retardation limit value, the retardation correction amount is set to the retardation limit value.

12. The control device of the internal combustion engine according to claim 10, wherein the advance limit value is set on a basis of any one of an ignition timing at which abnormal combustion of the internal combustion engine occurs and an ignition timing at which a sum of an energy distribution to a drive system of the internal combustion engine and an energy distribution to the coolant is maximized.

13. The control device of the internal combustion engine according to claim 11, wherein the retardation limit value is set on a basis of an ignition timing at which a combustion state of the internal combustion engine becomes unstable.

14. The control device of the internal combustion engine according to claim 2, wherein an advance limit value of the advance control and a retardation limit value of the retardation control are set on a basis of a range in which rotation of the internal combustion engine can be continued.

15. The control device of the internal combustion engine according to claim 2, wherein a thrott1e opening degree of the internal combustion engine is increased so as to compensate for torque of the internal combustion engine reduced by the advance control or the retardation control.
